(19) United States
(12) Patent Application Publication
(10) Pub. No.: US 2025/0116564 A1
(43) Pub. Date: Apr. 10, 2025

(54) Method For Diagnosing A Component By Means Of Acoustic Emission

(71) Applicant: SENSEVEN GMBH, Wiener Neudorf (AT)

(72) Inventors: Michael Hettegger, Vienna (AT); Christoph Altmann, Vienna (AT)

(73) Assignee: SENSEVEN GMBH, Wiener Neudorf (AT)

(21) Appl. No.: 18/832,014

(22) PCT Filed: Jan. 20, 2023
(86) PCT No.: PCT/EP2023/051416

§ 371 Date: Jul. 22, 2024

(30) Foreign Application Priority Data
Jan. 28, 2022 (EP) 22154015.6

(51) Int. Cl. G01M 3/24

(52) U.S. Cl. CPC G01M 3/24

(57) ABSTRACT

A method for establishing a diagnosis of a component installed in a pipeline, by acoustic emission examination, includes establishing the diagnosis taking into account a first and a second acoustic emission sensor signals. A distinguishing feature between the first and second acoustic emission sensor signals is taken into account for the diagnosis. The first acoustic emission sensor signal is output from one acoustic emission sensor and a first acoustic emission signal is detected at a first position on the pipeline by the sensor The first position is located at a height of the component installed in the pipeline. The second acoustic emission sensor signal has been output by a sensor and is detected by the sensor at a second position on the pipeline. The second position is located on the pipeline at a distance from the first position in or against the flow guiding direction from the first position.

### TECHNICAL FIELD

The invention relates to a method for establishing a diagnosis of a component, in particular a valve, by means of acoustic emission examination, which component is installed in a pipeline, which pipeline is designed to guide a fluid along a flow path in a flow guiding direction, and to a computer program product for carrying out this method. The invention also relates to a method for diagnosing a component, in particular a valve, by means of acoustic emission examination, which component is installed in a pipeline, which pipeline is designed to guide a fluid along a flow path in a flow guiding direction, and to an arrangement for carrying out this method.

### PRIOR ART

Methods, computer program products and arrangements belonging to the aforementioned technical field are known. For example, WO 2014/105839 A1 of Score Group PLC describes a method for acoustically determining leakage rates of a valve, whereby acoustic emission sensors are arranged radially around the valve in order to detect acoustic emission signals caused by the leakage of the valve. The leakage rate is determined and thus the diagnosis of the respective valve is established by analysing the acoustic emission signals detected by the acoustic emission sensors using a computer program product.

The disadvantage of these known methods, computer program products and arrangements is that they only enable establishing an insufficiently accurate and insufficiently reliable diagnosis or an insufficiently accurate and insufficiently reliable diagnosis of the valve.

### DESCRIPTION OF THE INVENTION

The task of the invention is to create a method, belonging to the technical field mentioned at the beginning, for establishing a diagnosis of a component, in particular a valve, which component is installed in a pipeline, which pipeline is designed for guiding a fluid along a flow path in a flow guiding direction, by means of acoustic emission examination, which method enables establishing a more accurate and reliable diagnosis of the component. It is further the task of the invention to create a computer program product for carrying out this method, which enables establishing a more accurate and reliable diagnosis of the component. In addition, it is the task of the invention to create a method for diagnosing a component, in particular a valve, which component is installed in a pipeline, which pipeline is designed for guiding a fluid along a flow path in a flow guiding direction, by means of acoustic emission examination, and to create an arrangement for carrying out the method for diagnosing the component, in particular valve, by means of acoustic emission examination, which enables a more accurate and reliable diagnosis of the valve.

The solution to the task is defined by the features of claim 1. According to the invention, the diagnosis of the component is established taking into account a first acoustic emission sensor signal and a second acoustic emission sensor signal, wherein a distinguishing feature between the first acoustic emission sensor signal and the second acoustic emission sensor signal is also taken into account for establishing the diagnosis, wherein the first acoustic emission sensor signal has been output by one of at least one acoustic emission sensor, wherein a first acoustic emission signal has been detected by the respective at least one acoustic emission sensor at a first position on the pipeline, in particular on the outside of the pipeline, wherein the first acoustic emission sensor signal output by the respective at least one acoustic emission sensor corresponds to the detected first acoustic emission signal, wherein the first position, viewed in the flow guiding direction, is at a level of the component installed in the pipeline, wherein the second acoustic emission sensor signal has been output by one of the at least one acoustic emission sensor, wherein a second acoustic emission signal is detected by the respective at least one acoustic emission sensor at a second position on the pipeline, in particular on the outside of the pipeline, a second acoustic emission signal has been detected, wherein the second acoustic emission sensor signal output by the respective at least one acoustic emission sensor corresponds to the detected second acoustic emission signal, wherein the second position is located at a distance from the first position in the flow guiding direction or against the flow guiding direction from the first position on the pipeline, in particular on the outside of the pipeline.

Preferably, a computer program product is configured to carry out the method according to the invention for establishing a diagnosis of a component. Preferably, the computer program product comprises instructions which, when the program is executed by a computer, cause the computer to execute the method according to the invention. Preferably, a diagnostic unit for establishing a diagnosis of a component with the method for establishing a diagnosis of a component is adapted to establish the diagnosis of the component with the method for establishing a diagnosis of a component. Particularly preferably, the diagnostic unit is a computer unit on which the computer program product for carrying out the method for establishing a diagnosis of a component is installed.

According to the invention, the component is installed in a pipeline, which pipeline is designed for guiding a fluid along a flow path in a flow guiding direction. The component can be, for example, a pipe section, a connecting piece for connecting pipe sections, a valve or a condensate separator. Since a condensate separator has at least one valve, the method can also be used to diagnose the at least one valve of the condensate separator. The pipeline can contain various components such as pipe sections, connecting pieces for connecting pipe sections, valves, condensate separators and pipe sections with sensors and can be composed of these components. However, the pipeline can also contain other components.

As already mentioned, the pipeline is designed to guide a fluid along a flow path in a flow guiding direction. The fluid can be a liquid, a gas or a mixture of a liquid and a gas, such as water vapour. Further, the flow path is preferably the path along which the fluid is directed in the pipeline. In other words, the flow path is preferably predetermined by the course of the pipeline.

As the component for which the diagnose is established is installed in a pipeline, the acoustic emission examination is carried out on the assembled pipeline. This has the advantage that a non-invasive diagnosis of the component is possible while the pipeline is in full operation. This is particularly advantageous in production plants in which pipelines are used for production. In such production plants, the present invention can thus be used to diagnose the components of the pipelines.

The diagnosis of the component preferably involves determining the condition of the respective component. In a preferred variant, the diagnosis of a component includes determining whether the respective component has a leak or not. In a preferred variation thereof, the diagnosis of a component also includes determining a leakage rate of the respective component. However, the diagnosis can also include no determination of the leakage rate. In a further preferred variation, the diagnosis of a component includes determining whether or not cavitations occur in the component. In a variation thereof, the diagnosis of a component also includes determining a cavitation rate of the respective component. However, the diagnosis can also include no determination of the cavitation rate.

According to the invention, a distinguishing feature between the first acoustic emission sensor signal and the second acoustic emission sensor signal is taken into account for establishing the diagnosis.

The distinguishing feature can, for example, be a difference in the intensity averaged over a predetermined frequency range for the two detected acoustic emission signals. Since the acoustic emission sensor signals correspond to the respective detected acoustic emission signal, the intensity of the first acoustic emission sensor signal averaged over the predetermined frequency range can, for example, be greater than the intensity of the second acoustic emission sensor signal averaged over the predetermined frequency range. The predetermined frequency range can, for example, be a sub-range of the frequency range detected by the at least one acoustic emission sensor or cover the entire frequency range detected by the respective acoustic emission sensor.

As already mentioned, the second acoustic emission sensor signal is output by one of the at least one acoustic emission sensors. The second acoustic emission sensor signal may have been output by the same acoustic emission sensor with which the first acoustic emission signal is detected at the first position on the pipeline, or the second acoustic emission sensor signal may have been output by a different acoustic emission sensor.

According to the invention, the diagnosis of the component is thus carried out taking into account a distinguishing feature between at least two acoustic emission sensor signals which correspond to acoustic emission signals detected at different positions along the flow path on the pipeline, one position (the first position) of which is at a level of the component installed in the pipeline as viewed in the flow guiding direction. This has the advantage that noises caused by the condition of the component can be at least partially distinguished from noises that are fundamentally present in the pipeline and caused by other sources and, for example, the fluid, thus enabling establishing a more accurate and reliable diagnosis of the component.

Advantageously, the diagnosis of the component is established taking into account a third acoustic emission sensor signal, wherein the third acoustic emission sensor signal has been output by one of the at least one acoustic emission sensor, wherein a third acoustic emission signal has been detected with the respective one of the at least one acoustic emission sensor at a third position on the pipeline, in particular on the outside of the pipeline, wherein the third acoustic emission sensor signal output by the respective one of the at least one acoustic emission sensor corresponds to the detected third acoustic emission signal. This has the advantage that establishing an even more accurate and reliable diagnosis is enabled. It is irrelevant whether the acoustic emission sensor with which the third acoustic emission sensor signal has been output is the same acoustic emission sensor with which the first acoustic emission signal has been detected at the first position on the pipeline and/or the same acoustic emission sensor with which the second acoustic emission signal has been detected at the second position on the pipeline, or may be a different acoustic emission sensor.

Preferably, viewed along the flow path, the third position is located on a different side of the first position than the second position is located from the first position, whereby the first position is located between the second position and the third position viewed along the flow path, wherein a distinguishing feature between the first acoustic emission sensor signal and the third acoustic emission sensor signal is taken into account for establishing the diagnosis. This has the advantage that both interfering noises in the detected acoustic emission signals, the source of which lies beyond the second position as seen from the first position, as well as interfering noises whose source lies beyond the third position as seen from the first position, can be identified as interfering noises. Accordingly, the evaluation of the acoustic emission sensor signals can be adapted so that the identified interfering noises are correctly treated as such. This enables a more precise diagnosis of the component.

In a preferred variant thereto, the third position as viewed along the flow path is on a different side of the second position than the first position is from the second position, whereby the second position as viewed along the flow path is between the first position and the third position, wherein a distinguishing feature between the first acoustic emission sensor signal or the second acoustic emission sensor signal and the third acoustic emission sensor signal is taken into account for making the diagnosis. This has the advantage that interfering noises in the detected acoustic emission signals, the source of which lies beyond the third position as seen from the first position, can be better quantified, thus enabling a more precise diagnosis of the component.

Preferably, the diagnosis of the component is established taking into account a fourth acoustic emission sensor signal, wherein the fourth acoustic emission sensor signal has been output by one of the at least one acoustic emission sensor, wherein a fourth acoustic emission signal has been detected by the respective one of the at least one acoustic emission sensor at a fourth position on the pipeline, in particular on the outside of the pipeline, wherein the fourth acoustic emission sensor signal output by the respective one of the at least one acoustic emission sensor corresponds to the detected fourth acoustic emission signal. This has the advantage that establishing an even more accurate and reliable diagnosis is enabled. The acoustic emission sensor from which the fourth acoustic emission sensor signal has been output can be the same acoustic emission sensor with which the first acoustic emission signal was detected at the first position on the pipeline, and/or the same acoustic emission sensor with which the second acoustic emission signal was detected at the second position on the pipeline, and/or the same acoustic emission sensor with which the third acoustic emission signal was detected at the third position on the pipeline, or can be a different acoustic emission sensor.

Preferably, along the flow path, the fourth position is located on a different side of the third position than the first position is located from the third position, whereby the third position is located between the first position and the fourth position along the flow path, wherein a distinguishing feature between the first acoustic emission sensor signal or the third acoustic emission sensor signal and the fourth acoustic emission sensor signal is taken into account for establishing the diagnosis.

Furthermore, if the third position is located on a different side of the first position than the second position is located from the first position when viewed along the flow path, the first position is located between the second position and the third position when viewed along the flow path, wherein a distinguishing feature between the first acoustic emission sensor signal and the third acoustic emission sensor signal is taken into account for establishing the diagnosis, this has the advantage that interference noise in the detected acoustic emission signals, the source of which lies beyond the fourth position as seen from the first position, can be better quantified, thereby enabling a more precise diagnosis of the component.

If, on the other hand, the third position as viewed along the flow path is on a different side of the second position than the first position is from the second position, whereby the second position as viewed along the flow path is between the first position and the third position, wherein a distinguishing feature between the first acoustic emission sensor signal or the second acoustic emission sensor signal and the third acoustic emission sensor signal is taken into account for establishing the diagnosis, this has the advantage that interfering noises in the detected acoustic emission signals, the source of which lies beyond the fourth position as seen from the first position, can be quantified even better than interfering noises, the sources of which lie beyond the third position as seen from the first position, thus enabling an even more precise diagnosis of the component.

Preferably, the diagnosis of the component is established taking into account a fifth acoustic emission sensor signal, wherein the fifth acoustic emission sensor signal has been output by one of the at least one acoustic emission sensor, wherein a fifth acoustic emission signal has been detected by the respective one of the at least one acoustic emission sensor at a fifth position on the pipeline, in particular on the outside of the pipeline, wherein the fifth acoustic emission sensor signal output by the respective one of the at least one acoustic emission sensor corresponds to the detected fifth acoustic emission signal. This has the advantage that establishing an even more accurate and reliable diagnosis is enabled. The acoustic emission sensor from which the fifth acoustic emission sensor signal was output can be the same acoustic emission sensor with which the first acoustic emission signal was detected at the first position on the pipeline, and/or the same acoustic emission sensor with which the second acoustic emission signal was detected at the second position on the pipeline, and/or be the same acoustic emission sensor with which the third acoustic emission signal was detected at the third position on the pipeline, and/or be the same acoustic emission sensor with which the fourth acoustic emission signal was detected at the fourth position on the pipeline, or may be a different acoustic emission sensor.

Preferably, along the flow path, the fifth position is located on a different side of the first position than the third position is located from the first position, whereby the first position is located between the third position and the fifth position when viewed along the flow path, whereby the fifth position is located on a different side of the second position than the third position is located from the second position when viewed along the flow path, whereby the second position as viewed along the flow path is located between the third position and the fifth position, wherein a distinguishing feature between the first acoustic emission sensor signal or the second acoustic emission sensor signal and the fifth acoustic emission sensor signal is taken into account for establishing the diagnosis.

Furthermore, if along the flow path the third position is located on a different side of the first position than the second position is located from the first position, whereby the first position is located between the second position and the third position as viewed along the flow path, wherein a distinguishing feature between the first acoustic emission sensor signal and the third acoustic emission sensor signal is taken into account for establishing the diagnosis, this has the advantage that both interference noises in the detected acoustic emission signals, the source of which lies beyond the fourth position as seen from the first position, and interference noises in the detected acoustic emission signals, the source of which lies beyond the fifth position as seen from the first position, can be better quantified, thus enabling a significantly more precise diagnosis of the component.

If, on the other hand, the third position as viewed along the flow path is located on a different side of the second position than the first position is located from the second position, whereby the second position as viewed along the flow path is located between the first position and the third position, wherein a distinguishing feature between the first acoustic emission sensor signal or the second acoustic emission sensor signal and the third acoustic emission sensor signal is also taken into account for establishing the diagnosis, this has the advantage that, on the one hand, interfering noises in the detected acoustic emission signals, the source of which, as viewed from the first position, is located beyond the fourth position, can be quantified even better than interfering noises whose sources are located from the first position, and that, on the other hand, interference noise in the detected acoustic emission signals whose source lies beyond the fifth position as seen from the first position can also be quantified better, thus enabling a more precise diagnosis of the component.

As an alternative to these variants, it is also possible that only four acoustic emission signals, only three acoustic emission signals or only two acoustic emission signals are detected. Accordingly, in these variants, only the first, second, third and fourth acoustic emission sensor signals, only the first, second and third acoustic emission sensor signals or only the first and second acoustic emission sensor signals are taken into account when establishing the diagnosis.

Advantageously, the acoustic emission sensor signals are electronic signals which are output by the respective acoustic emission sensor detecting the respective acoustic emission signal and thereby reproduce the respective detected acoustic emission signal with time resolution or frequency resolution and thus corresponding to the respective detected acoustic emission signal. The acoustic emission sensor signals can be analogue or digital electrical signals. Regardless of whether the acoustic emission sensor signals are analogue or digital electrical signals, time-resolved preferably means an amplitude, the absolute value of the amplitude or intensity (i.e. the squared absolute value of the amplitude), which corresponds to the respective time-resolved acoustic emission signal, while frequency-resolved preferably means the Fourier transformation of the time-resolved acoustic emission signal or the acoustic emission signal in frequency space.

Advantageously, the acoustic emission signals detected with the at least one acoustic emission sensor, in particular with each of the at least one acoustic emission sensor, in particular the first acoustic emission signal, the second acoustic emission signal and, if the third acoustic emission signal is detected or has been detected, also the third acoustic emission signal, if the fourth acoustic emission signal is detected or has been detected, also the fourth acoustic emission signal, and, if the fifth acoustic emission signal is detected or has been detected, also the fifth acoustic emission signal, are detected over a frequency range. Advantageously, the frequency range is the range from about 1 kHz to about 1 MHz, preferably from 1 kHz to 1 MHz, particularly preferably from 25 kHz to 500 kHz, most preferably from 25 kHz to 300 kHz. Preferably, the acoustic emission signals output by the respective acoustic emission sensor also cover this frequency range, in particular from about 1 kHz to about 1 MHz, or from 1 kHz to 1 MHz, or from 25 kHz to 500 kHz, or from 25 kHz to 300 kHz.

Since in the case of defective components, especially leaking valves, the vibrations caused by the defect or leakage cause acoustic emission signals in this frequency range, while many or interfering noises, which are in the range audible to the human ear, are not included in the acoustic emission signals. This means that the acoustic emission signals required for diagnosing the component can also be detected in an environment that is noisy for humans, such as a production hall in a factory.

In a variant thereto, the acoustic emission signals detected with the at least one acoustic emission sensor, in particular with each of the at least one acoustic emission sensor, in particular the first acoustic emission signal, the second acoustic emission signal and, if the third acoustic emission signal is detected or has been detected, also the third acoustic emission signal, if the fourth acoustic emission signal is detected or has been detected, also the fourth acoustic emission signal, and, if the fifth acoustic emission signal is detected or has been detected, also the third acoustic emission signal, are detected over a frequency range which does not range from about 1 kHz to about 1 MHZ, respectively from 1 kHz to 1 MHz, or from 25 kHz to 500 kHz, or from 25 kHz to 300 kHz. The acoustic emission signals output by the respective acoustic emission sensor can also cover a frequency range other than from about 1 kHz to about 1 MHZ, or from 1 kHz to 1 MHz, or from 25 kHz to 500 kHz, or from 25 kHz to 300 KHz.

Preferably, the respective acoustic emission signal is continuously recorded at each of the positions with the respective one of the at least one acoustic emission sensor for a period of at least 1 s, particularly preferably at least 2 s. This has the advantage that an analysis of the acoustic emission sensor signals, in particular a frequency-dependent analysis of the acoustic emission sensor signals, provides a more reliable result. Preferably, the respective acoustic emission signal is continuously detected at each of the positions with the respective one of the at least one acoustic emission sensor for a period of at most 20 s, particularly preferably at most 10 s, very particularly preferably at most 5 s. This has the advantage that the detection of the acoustic emission signals requires only a short time. Preferably, the respective acoustic emission signal is continuously detected at each of the positions with the respective one of the at least one acoustic emission sensor for a period of 1 s to 20 s or 1 s to 10 s, particularly preferably from 2 s to 10 s, very particularly preferably from 2 s to 5 s.

Alternatively, however, it is also possible for the respective acoustic emission signal to be recorded continuously at each of the positions for a period of less than 1 s or more than 20 s using the respective one of the at least one acoustic emission sensor.

Advantageously, the acoustic emission sensor signals are filtered with a prefilter for establishing the diagnosis of the component, wherein the prefilter comprises a prefilter criterion, wherein the prefiltered acoustic emission sensor signals are used as acoustic emission sensor signals for establishing the diagnosis of the component for further processing of the acoustic emission sensor signals. It is irrelevant whether this prefiltering still takes place in the acoustic emission sensor with which the respective acoustic emission signal is detected, and whether the acoustic emission sensor signal is already output by the respective acoustic emission sensor as a prefiltered acoustic emission sensor signal of the detected acoustic emission signal, or whether the acoustic emission sensor signal output by the respective acoustic emission sensor is prefiltered.

Preferably, the prefiltering includes the time-resolved reproduction of the respective detected acoustic emission signal by the respective acoustic emission sensor signal and the subdivision of the respective time-resolved acoustic emission sensor signal into sections. Preferably, for prefiltering, at least one characteristic number of the respective acoustic emission sensor signal is then determined for each of the sections of the respective acoustic emission sensor signal, the prefilter criterion being applied to the values of the at least one characteristic number determined for the various sections and one or more sections of the respective acoustic emission sensor signal being selected on the basis of the prefilter criterion and the selected section or sections being used as the respective prefiltered acoustic emission sensor signal for establishing the diagnosis of the component.

Preferably, the respective time-resolved sound emission sensor signal is divided into at least 10 sections, particularly preferably into at least 20 sections. Preferably, the respective time-resolved sound emission sensor signal is subdivided into a maximum of 1,000 sections. In variants thereof, however, the respective time-resolved sound emission sensor signal is subdivided into fewer than 10 sections or more than 1,000 sections.

Preferably, the sections each correspond to a duration of at least 10 ms, particularly preferably at least 20 ms, even more preferably at least 50 ms, most preferably at least 100 ms, of the respective detected acoustic emission signal. Preferably, the sections also each correspond to a duration of at most 30 s, at most 20 s, at most 10 s or at most 2 s of the respective detected acoustic emission signal. However, the sections can also correspond to a duration of more than 30 s or less than 10 ms of the respective detected acoustic emission signal.

Preferably, one of the at least one characteristic number is a root mean square (RMS_{section}) of the respective acoustic emission sensor signal within the respective section. Preferably, the root mean square (RMS_{section}) is calculated according to the formula

$${RMS}_{s e c t i o n} = \sqrt{\frac{1}{m} {Σ}_{j = 1}^{m} {w}_{j}^{2}} ,$$

where m is the number of data points in the respective section of the respective acoustic emission sensor signal and wⱼ is the value of the j^{th} data point in the respective section of the respective acoustic emission sensor signal.

Preferably, the at least one characteristic number is exactly one characteristic number. Regardless of whether the characteristic number is the root mean square (RMS_{section}) or not, the prefilter criterion is preferably the median value of the values of this exactly one characteristic number determined for the sections of the respective acoustic emission sensor signal. Accordingly, the section of the respective acoustic emission sensor signal whose value of the characteristic number comes closest to the median value of the values of this characteristic number determined for the sections of the respective acoustic emission sensor signal is preferably used as the respective pre-filtered acoustic emission sensor signal. If the number of sections of the respective acoustic emission sensor signal is odd, the section of the respective acoustic emission sensor signal whose value of the characteristic number is the median value of the values determined for the sections of the respective acoustic emission sensor signal is used as the respective pre-filtered acoustic emission sensor signal. If the value of the characteristic number for several sections of the respective acoustic emission sensor signal is equal to the median value, one of these sections or several of these sections can be used as the respective pre-filtered acoustic emission sensor signal. In the case of an even number of sections of the respective acoustic emission sensor signal, on the other hand, at least one of the sections of the respective acoustic emission sensor signal whose value of the characteristic number is the median or whose value is the lower median or upper median, as the case may be, is used as the respective pre-filtered acoustic emission sensor signal.

By filtering the acoustic emission sensor signals with a prefilter to establish the diagnosis of the component, whereby the prefilter criterion is the median value of the values determined for the sections of the respective acoustic emission sensor signal of exactly one characteristic number, the advantage is achieved that outliers of the measured values in the respective recorded acoustic emission signals can be eliminated. Accordingly, the pre-filtered acoustic emission sensor signals used contain more reliable information about the condition of the component, which makes the diagnosis of the component more reliable.

However, it is also possible for a different prefilter criterion to be applied to the values of the at least one characteristic number determined for the various sections. For example, the mean value can also be used instead of the median. It is also possible that the square mean (RMS section) of the respective acoustic emission sensor signal within the respective section is not used as the characteristic number. For example, the sum of the points of the respective acoustic emission sensor signal within the respective section can also be used as the characteristic number.

As an alternative to these variants, however, it is also possible to dispense with prefiltering, i.e. the acoustic emission sensor signals are not filtered with a prefilter to establish the diagnosis of the component.

Advantageously, for establishing the diagnosis of the component, for each acoustic emission sensor signal, i.e. for the first acoustic emission sensor signal, the second acoustic emission sensor signal, possibly the third acoustic emission sensor signal, possibly the fourth acoustic emission sensor signal and possibly the fifth acoustic emission sensor signal, a coupling strength of the respective one of the at least one acoustic emission sensor at the respective position on the pipeline, in particular on the outside of the pipeline, i.e. at the first position, at the second position, possibly at the third position, possibly at the fourth position or possibly at the fifth position, is taken into account when detecting the acoustic emission signal corresponding to the respective acoustic emission sensor signal. This has the advantage that differences in the intensity of the acoustic emission sensor signals caused by different coupling strengths can be taken into account when establishing the diagnosis of the component, which means that the diagnosis of the component can be established with an increased precision.

Preferably, at the respective position on the pipeline, in particular on the outside of the pipeline, i.e. at the first position, at the second position, if necessary at the third position, if necessary at the fourth position or, if necessary, at the fifth position, before the respective acoustic emission signal has been detected with the one of the at least two acoustic emission sensors with which the respective acoustic emission signal has been detected at the respective position on the pipeline, in particular on the outside of the pipeline, the respective acoustic emission sensor has been positioned on the respective position on the pipeline, in particular on the outside of the pipeline, and an acoustic coupling of the respective acoustic emission sensor to the pipeline has been verified. At least two acoustic emission sensors are preferably used for this purpose. Preferably, in addition to the fact that the respective one of the at least two acoustic emission sensors has been positioned at the respective position on the pipeline, in particular on the outside of the pipeline, another one of the at least two acoustic emission sensors has been positioned at a position neighbouring the respective position on the pipeline, in particular on the outside of the pipeline, after which the test sound signal is output with the other one of the at least two acoustic emission sensors, while the test sound signal is recorded with the acoustic emission sensor whose acoustic coupling to the pipeline has been verified. Preferably, based on the test sound signal detected by the respective acoustic emission sensor, a reception strength and thus a coupling strength of the test sound signal detected by the respective acoustic emission sensor is determined. If the determined reception strength or the coupling strength was below a predetermined minimum strength, the respective acoustic emission sensor is preferably repositioned at the respective position and its acoustic coupling to the pipeline is checked until the determined reception strength or coupling strength has at least corresponded to the predetermined minimum strength. Advantageously, the respective acoustic emission signal is only detected by the respective acoustic emission sensor and the acoustic emission sensor signal corresponding to the respective detected acoustic emission signal is only output by the respective acoustic emission sensor when the reception strength or coupling strength determined for the respective acoustic emission sensor at the respective position corresponds to at least the specified minimum strength. This has the advantage of ensuring that the acoustic emission signals have been detected sufficiently well.

Alternatively, it is also possible that the acoustic coupling of the acoustic emission sensor used to detect the respective acoustic emission signal has not been verified.

Advantageously, an aggregate state of the fluid and/or a medium of the fluid is taken into account for establishing the diagnosis of the component. This has the advantage that characteristics in the acoustic emission signals, which are caused by the aggregate state of the fluid or by the medium of the fluid, can be taken into account for the diagnosis of the component. The medium can be water or air, for example, or a mixture of air and water vapour. However, the medium can also be something other than water or air. For example, the medium can be oil or natural gas. In the same way, the medium can also be a mixture of different chemicals such as pharmaceuticals.

Alternatively, it is also possible that neither the aggregate state of the fluid nor the medium of the fluid is taken into account for the diagnosis of the component.

Advantageously, a temperature and/or viscosity of the fluid is taken into account for establishing the diagnosis of the component. This has the advantage that characteristics in the acoustic emission signals, which are caused by the temperature or viscosity of the fluid, can also be taken into account for the diagnosis of the component.

Alternatively, it is also possible that neither the temperature nor the viscosity of the fluid are taken into account when establishing the diagnosis of the component.

Preferably, a pressure difference, in particular a pressure drop, in the pipeline across the component installed in the pipeline is taken into account when establishing the diagnosis of the component. The pressure difference in the pipeline across the component installed in the pipeline is preferably a difference between a pressure at which the fluid is at a first point in the pipeline, as seen from the component, along the flow path against the flow guiding direction just adjacent to the component, and a pressure at which the fluid is at a second point in the pipeline, as seen from the component, along the flow path in the flow guiding direction just adjacent to the component. If the component is a valve, the pressure difference is preferably a pressure drop when viewed in the flow guiding direction. If, on the other hand, the component is a pump, the pressure difference in the flow guiding direction can also be an increase in pressure. Preferably, the pressure difference is determined by a pressure measurement at the first point and by a pressure measurement at the second point, with the difference between the two pressure measurements being the pressure difference.

Taking into account the pressure difference, in particular pressure drop, in the pipeline across the component installed in the pipeline for the establishing diagnosis of the component has the advantage that characteristics in the acoustic emission signals, which are caused by different flow velocities of the fluid, can also be taken into account.

Regardless of whether or not the pressure difference, in particular the pressure drop, in the pipeline across the component installed in the pipeline is taken into account for establishing the diagnosis of the component, the pressure under which the fluid is at a point in the pipeline just adjacent to the component as seen from the component along the flow path against the flow guiding direction can also be taken into account.

Advantageously, the component type of the component is taken into account when establishing the diagnosis of the component, whereby if the component is a valve, the valve type is taken into account. As explained above, the component can be, for example, a pipe section, a connector for connecting pipe sections, a valve or a condensate separator. Accordingly, the component type is preferably a pipe section, a connecting piece for connecting pipe sections, a valve or a condensate separator. This has the advantage that a component type-dependent diagnosis of the component is possible, which enables a more reliable diagnosis because component type-dependent characteristics in the acoustic emission signals can be taken into account.

Preferably, a size of the component, in particular an inside diameter, is also taken into account when establishing the diagnosis of the component, whereby, if the component is a valve, a nominal size of the valve is taken into account as the size of the component.

As an alternative to these variants, however, it is also possible that neither the size of the component nor the component type is taken into account when establishing the diagnosis of the component.

If the acoustic emission sensor signals are filtered with a prefilter to establish the diagnosis of the component as described above, the prefilter comprising a prefilter criterion, the prefiltered acoustic emission sensor signals are preferably used as acoustic emission sensor signals to establish the diagnosis of the component for further processing of the acoustic emission sensor signals as already mentioned. Therefore, in case in the following it is referred to a use of the detected acoustic emission signals, a use of the acoustic emission sensor signals, a calculation based on the detected acoustic emission signals or a calculation based on the acoustic emission sensor signals, the respective pre-filtered acoustic emission sensor signal is preferably meant in this case. I.e., in the variant described below as preferred, where a Fast Fourier Transform is calculated from each of the detected acoustic emission signals to establish the diagnosis of the component, for example, the Fast Fourier Transform is preferably calculated from the pre-filtered acoustic emission sensor signal to establish the diagnosis of the component, after which this Fast Fourier Transform is then used to establish the diagnosis of the component.

Preferably, a Fast Fourier Transform is calculated from each of the detected acoustic emission signals to establish the diagnosis of the component. Thereby, it is irrelevant whether the Fast Fourier Transform is still calculated in the acoustic emission sensor with which the respective acoustic emission signal is detected, and whether the acoustic emission sensor signal is output by the respective acoustic emission sensor as a Fast Fourier Transform of the detected acoustic emission signal, or whether the Fast Fourier Transform is calculated from the respective acoustic emission sensor signal. Irrespective of this, the Fast Fourier transform has the advantage that one or more sub-ranges of the frequency range over which the acoustic emission signals are detected can be evaluated separately for the diagnosis of the component by evaluating the desired sub-range of the Fast Fourier transform of the acoustic emission sensor signal corresponding to the respective acoustic emission signal separately or by evaluating the desired sub-ranges of the Fast Fourier transform of the acoustic emission sensor signal corresponding to the respective acoustic emission signal separately.

Alternatively, it is also possible that no Fast Fourier Transform is calculated from each of the detected acoustic emission signals to establish the diagnosis of the component. This can be the case, for example, if the diagnosis of the component is established by an evaluation method based on supervised machine learning.

Preferably, the acoustic emission sensor signals are analysed over a sub-range of the frequency range over which the acoustic emission signals are detected in order to establish the diagnosis of the component. This has the advantage that the most suitable sub-range can be selected for the evaluation depending on the situation.

If an aggregate state of the fluid and/or a medium of the fluid is taken into account for the establishing the diagnosis of the component and the medium is steam, in particular steam composed of a mixture of air and water, the sub-range is preferably from about 200 kHz to about 250 kHz, particularly preferably from 200 kHz to 250 kHz. However, the sub-range can also be selected higher and be from about 250 kHz to about 300 kHz, in particular from 250 kHz to 300 kHz. However, the sub-range can also be selected to be even higher, for example from about 300 kHz to about 350 kHz, in particular from 300 kHz to 350 kHz.

If a state of aggregation of the fluid and/or a medium of the fluid is taken into account for establishing the diagnosis of the component, where the medium is not vapour, in particular if the state of aggregation of the fluid is either gaseous or liquid or if the medium is either a gas or a liquid, the sub-range is preferably from about 25 kHz to about 50 kHz, particularly preferably from 25 kHz to 50 kHz. The sub-range can also be selected higher and be from about 50 kHz to about 100 kHz, in particular from 50 kHz to 100 kHz. However, the sub-range can also be selected to be even higher, for example from about 100 kHz to about 150 kHz, in particular from 100 kHz to 150 kHz.

However, if the fluid medium is water, the sub-range is preferably from about 20 kHz to about 400 kHz, particularly preferably from 20 kHz to 400 kHz.

Advantageously, the acoustic emission sensor signals are evaluated over the sub-range of the frequency range over which the acoustic emission signals are detected in order to establish the diagnosis of the component by determining at least one characteristic number of the respective acoustic emission sensor signal for this sub-range. The at least one characteristic number of the respective acoustic emission sensor signal can be determined for the entire sub-range or for one or more sections of the sub-range, such as area sections of the sub-range. Irrespective of this, determining at least one characteristic number for the sub-range of the respective acoustic emission sensor signal has the advantage that the various acoustic emission sensor signals can be compared with each other in a simple manner on the basis of the characteristic numbers. In a preferred variant, the acoustic emission sensor signals are evaluated over the sub-range of the frequency range over which the acoustic emission signals are detected in order to establish the diagnosis of the component by determining the at least one characteristic number of the respective acoustic emission sensor signal for the entire sub-range.

Preferably, one of the at least one characteristic number is a root mean square (RMS) of the respective acoustic emission sensor signal within the sub-range. Preferably, the root mean square (RMS) is calculated according to the formula

$$RMS = \sqrt{\frac{1}{n} {Σ}_{i = 1}^{n} {f}_{i}^{2}}$$

where n is the number of data points in the Fast Fourier Transform in the sub-range and fᵢ is the value of the i-th data point in the Fast Fourier Transform in the sub-range.

Preferably, the at least one characteristic number is at least two characteristic numbers, wherein one of these at least two characteristic numbers is the maximum amplitude of the respective acoustic emission sensor signal within the sub-range and one of these at least two characteristic numbers is an average amplitude of the respective acoustic emission sensor signal.

Alternatively, it is also possible for the at least two characteristic numbers to be other characteristic numbers. It is also possible that at least one characteristic number is only one characteristic number.

Preferably, as distinguishing feature between one of the acoustic emission sensor signals and another of the acoustic emission sensor signals, a difference between the at least one characteristic number, which was determined for the sub-range of one of the acoustic emission sensor signals, and the at least one characteristic number, which was determined for the sub-range of the another of the acoustic emission sensor signals, is used. In other words, advantageously, a difference between the at least one characteristic number determined for the sub-range of the first acoustic emission sensor signal and the at least one characteristic number determined for the sub-range of the second acoustic emission sensor signal is used as a distinguishing feature between the first acoustic emission sensor signal and the second acoustic emission sensor signal for establishing the diagnosis. If a distinguishing feature between the first acoustic emission sensor signal and the third acoustic emission sensor signal is also taken into account for establishing the diagnosis, a difference between the at least one characteristic number determined for the sub-range of the first acoustic emission sensor signal and the at least one characteristic number determined for the sub-range of the third acoustic emission sensor signal is preferably used as a distinguishing feature between the first acoustic emission sensor signal and the third acoustic emission sensor signal for establishing the diagnosis. If a distinguishing feature between the second acoustic emission sensor signal and the third acoustic emission sensor signal is also taken into account for establishing the diagnosis, a difference between the at least one characteristic number determined for the sub-range of the second acoustic emission sensor signal and the at least one characteristic number determined for the sub-range of the third acoustic emission sensor signal is preferably used as a distinguishing feature between the second acoustic emission sensor signal and the third acoustic emission sensor signal for establishing the diagnosis. If a distinguishing feature between the first acoustic emission sensor signal and the fourth acoustic emission sensor signal is also taken into account for establishing the diagnosis, a difference between the at least one characteristic number determined for the sub-range of the first acoustic emission sensor signal and the at least one characteristic number determined for the sub-range of the fourth acoustic emission sensor signal is preferably used as a distinguishing feature between the first acoustic emission sensor signal and the fourth acoustic emission sensor signal for establishing the diagnosis. If a distinguishing feature between the third acoustic emission sensor signal and the fourth acoustic emission sensor signal is also taken into account for establishing the diagnosis, a difference between the at least one characteristic number determined for the sub-range of the third acoustic emission sensor signal and the at least one characteristic number determined for the sub-range of the fourth acoustic emission sensor signal is preferably used as a distinguishing feature between the third acoustic emission sensor signal and the fourth acoustic emission sensor signal for establishing the diagnosis. If a distinguishing feature between the first acoustic emission sensor signal and the fifth acoustic emission sensor signal is also taken into account for establishing the diagnosis, a difference between the at least one characteristic number determined for the sub-range of the first acoustic emission sensor signal and the at least one characteristic number determined for the sub-range of the fifth acoustic emission sensor signal is preferably used as the distinguishing feature between the first acoustic emission sensor signal and the fifth acoustic emission sensor signal for establishing the diagnosis. If a distinguishing feature between the second acoustic emission sensor signal and the fifth acoustic emission sensor signal is also taken into account for establishing the diagnosis, a difference between the at least one characteristic number determined for the sub-range of the second acoustic emission sensor signal and the at least one characteristic number determined for the sub-range of the fifth acoustic emission sensor signal is preferably used as a distinguishing feature between the second acoustic emission sensor signal and the fifth acoustic emission sensor signal for establishing the diagnosis.

As an alternative to these variants, however, it is also possible that the distinguishing feature between one of the acoustic emission sensor signals and another of the acoustic emission sensor signals is not a difference between the at least one characteristic number determined for the sub-range of one of the acoustic emission sensor signals and the at least one characteristic number determined for the sub-range of the other of the acoustic emission sensor signals. For example, the characteristic numbers can also be used on their own. This can be the case, for example, if the diagnosis of the component is established by an evaluation method based on supervised machine learning.

Preferably, the diagnosis of the component is established by taking into account the first acoustic emission sensor signal as well as at least two further acoustic emission sensor signals, i.e. based on the first acoustic emission sensor signal, as well as at least two of the aforementioned second acoustic emission sensor signal, the aforementioned third acoustic emission sensor signal, the aforementioned fourth acoustic emission sensor signal and the aforementioned fifth acoustic emission sensor signal, wherein the first position is located between the two positions as viewed along the flow path, at which two of the at least two further ones of the acoustic emission sensor signals have been detected, wherein, if a condition is met for one of the at least one characteristic number, in particular the root mean square (RMS) of the respective acoustic emission sensor signal within the sub-range or the average amplitude of the respective acoustic emission sensor signal within the sub-range, the one of the at least one characteristic number determined for the sub-range of the first acoustic emission sensor signal has a value which value lies between the value of the one of the at least one characteristic number determined for the sub-range of the one of the two of the at least two further of the acoustic emission sensor signals and the value of the one of the at least one characteristic number determined for the sub-range of the other of the two of the at least two further of the acoustic emission sensor signals, the sub-range within the frequency range, over which frequency range the acoustic emission signals are detected, is shifted to higher frequencies, and the acoustic emission sensor signals are evaluated over the shifted sub-range of the frequency range over which frequency range the acoustic emission signals are detected in order to establish the diagnosis of the component, in that the at least one characteristic number of the respective acoustic emission sensor signal is determined for this shifted sub-range.

In other words, the evaluation described above for the sub-range is repeated for the shifted sub-range. Thus, the evaluation described above for the sub-range with subsequent shifting of the sub-range and repeated evaluation for the shifted sub-range can be repeated several times, so that ultimately, the sub-range is shifted several times, until the condition, according to which the value of the respective characteristic number, which was determined for the sub-range of the first acoustic emission sensor signal, lies between the values of the respective characteristic number, which was determined for the sub-range for the two of the at least two further acoustic emission sensor signals, the sub-range within the frequency range over which frequency range the acoustic emission signals are detected is no longer fulfilled and the last sub-range obtained is used for further evaluation for establishing the diagnosis.

This procedure has the advantage that noise caused by sources located away from the first position and thus away from the component for which the diagnosis is being established can be suppressed, as a sub-range is searched for in which the noise is not present in the detected acoustic emission sensor signals or at least only plays a subordinate role. This makes it possible to establish a more precise diagnosis of the component.

With this procedure, it is irrelevant whether the shifted sub-range is completely outside or above the previously used sub-range or whether the shifted sub-range partially overlaps with the previously used sub-range. The latter is the case, for example, if the sub-range is only shifted slightly to higher frequencies, e.g. if the sub-range extends over 25 kHz and the lower limit and upper limit of the sub-range are only shifted upwards by 5 kHz.

If an aggregate state of the fluid and/or a medium of the fluid is taken into account for establishing the diagnosis of the component and the medium is steam, in particular steam composed of a mixture of air and water, the sub-range on which the described evaluation is carried out is preferably from about 200 kHz to about 250 kHz, particularly preferably from 200 kHz to 250 kHz, while the shifted sub-range is from about 250 kHz to about 300 kHz, particularly from 250 kHz to 300 kHz, or from about 300 kHz to about 350 kHz, particularly from 300 kHz to 350 kHz. If, on the other hand, the sub-range on which the described evaluation is performed is from about 250 kHz to about 300 kHz, particularly preferably from 250 kHz to 300 kHz, the shifted sub-range is preferably from about 300 kHz to about 350 kHz, particularly from 300 kHz to 350 kHz. In the latter case, the sub-range from about 250 kHz to about 300 kHz, particularly preferably from 250 kHz to 300 kHz, on which the described evaluation is performed, may already be a shifted sub-range. I.e, the evaluation described above for the sub-range with subsequent shifting of the sub-range and repeated evaluation for the shifted sub-range can be repeated several times, so that ultimately the sub-range is shifted several times until the condition, according to which the value of the respective characteristic number, which was determined for the respective sub-range of the first acoustic emission sensor signal lies between the values of the respective characteristic number which has been determined for the respective sub-range for the two of the at least two further acoustic emission signals, the respective sub-range within the frequency range over which frequency range the acoustic emission signals are detected is no longer fulfilled and the last sub-range obtained is used for further evaluation for establishing the diagnosis.

If an aggregate state of the fluid and/or a medium of the fluid is taken into account for establishing the diagnosis of the component, the medium not being vapour, in particular if the aggregate state of the fluid is either gaseous or liquid, or if the medium is either a gas or a liquid, the sub-range is preferably from about 25 kHz to about 50 kHz, particularly preferably from 25 kHz to 50 kHz, while the shifted sub-range is from about 50 kHz to about 100 kHz, particularly from 50 kHz to 100 kHz, or from about 100 kHz to about 150 kHz, particularly from 100 kHz to 150 kHz. If, on the other hand, the sub-range on which the described evaluation is performed is from about 50 kHz to about 100 kHz, particularly preferably from 50 kHz to 100 kHz, the shifted sub-range is preferably from about 100 kHz to about 150 kHz, particularly from 100 kHz to 150 kHz. In the latter case, the sub-range from about 50 kHz to about 100 kHz, particularly preferably from 50 kHz to 100 kHz, on which the described evaluation is carried out, can already be a shifted sub-range.

Alternatively, there is also the possibility that the sub-range is not shifted as described above.

Advantageously, the diagnosis of the component is established taking into account the first acoustic emission sensor signal and at least one other of the acoustic emission sensor signals, i.e. based on the first acoustic emission sensor signal, as well as at least one of the aforementioned second acoustic emission sensor signal, the aforementioned third acoustic emission sensor signal, the aforementioned fourth acoustic emission sensor signal and the aforementioned fifth acoustic emission sensor signal, wherein, if for one of the at least one characteristic number, in particular the root mean square (RMS) of the respective acoustic emission sensor signal within the sub-range or the average amplitude of the respective acoustic emission sensor signal, within the sub-range a condition is fulfilled, according to which the one of the at least one characteristic number determined for the sub-range of the first acoustic emission sensor signal has a value which is greater by at least one threshold value than the value of the one of the at least one characteristic number determined for the sub-range of the at least one other of the acoustic emission sensor signals, the component is diagnosed as defective as a diagnosis of the component.

Thus, as a distinguishing feature between the first acoustic sensor signal and the at least one further acoustic emission sensor signal a difference between the at least one characteristic number determined for the sub-range of the first acoustic emission sensor signal and the at least one characteristic number determined for the sub-range of the at least one further acoustic emission sensor signal and is taken into account for establishing the diagnosis of the component. This has the advantage of enabling reliable diagnosis of the component.

If the diagnosis of the component is established by taking into account the first acoustic emission sensor signal and at least two other of the acoustic emission sensor signals, i.e. based on the first acoustic emission sensor signal, as well as at least two of the aforementioned second acoustic emission sensor signal, the aforementioned third acoustic emission sensor signal, the aforementioned fourth acoustic emission sensor signal and the aforementioned fifth acoustic emission sensor signal, wherein the first position along the flow path is located between the two positions at which two of the at least two further acoustic emission signals have been detected, the component is preferably diagnosed as defective only if for one of the at least one characteristic number, in particular the root mean square (RMS) of the respective acoustic emission sensor signal within the sub-range or the average amplitude of the respective acoustic emission sensor signal within the sub-range, the condition is met according to which the one of the at least one characteristic number determined for the sub-range of the first acoustic emission sensor signal has a value which value is greater by at least the threshold value than the value of the one of the at least one characteristic number determined for the sub-range of the one of the two of the at least two further acoustic emission sensor signals and greater by at least the threshold value than the value of the one of the at least one characteristic number determined for the sub-range of the other of the two of the at least two further acoustic emission sensor signals. This procedure has the advantage that interference noise caused by sources located away from the first position and thus away from the component for which the diagnosis is being established is suppressed, as it is ensured that no such interference noise is present in the detected acoustic emission sensor signals or at least only plays a subordinate role. Accordingly, this enables establishing a more precise and reliable diagnosis of the component.

Advantageously, for establishing the diagnosis of the component, the component is diagnosed as defective only if for each of the other acoustic emission sensor signals additionally detected in addition to the first acoustic emission sensor signal, i.e. the second acoustic emission sensor signal, possibly the third acoustic emission sensor signal, possibly the fourth acoustic emission sensor signal and possibly the fifth acoustic emission sensor signal, for one of the at least one characteristic number, in particular the root mean square (RMS) of the respective acoustic emission sensor signal within the sub-range or the average amplitude of the respective acoustic emission sensor signal within the sub-range, the condition is fulfilled according to which the one of the at least one characteristic number determined for the sub-range of the first acoustic emission sensor signal has a value which is greater by at least the threshold value than the value of the one of the at least one characteristic number determined for the sub-range of the respective one of the further acoustic emission sensor signals additionally detected in addition to the first acoustic emission sensor signal. This procedure has the advantage that interference noise caused by sources located away from the first position and thus away from the component for which the diagnosis is being established is suppressed, as it is ensured that no such interference noise is present in the detected acoustic emission sensor signals or at least only plays a subordinate role. Accordingly, this enables establishing a more precise and reliable diagnosis of the component.

If the component is a valve and the acoustic emission signals have been detected when the valve is closed, preferably a leak in the valve is diagnosed, i.e. the valve is diagnosed as leaking, when the component is diagnosed as defective. In a preferred variant thereof, the leakage rate of the valve is determined as a function of how much the value of the respective characteristic number, which was determined for the sub-range of the first acoustic emission sensor signal, is greater than the value of the respective characteristic number, which was determined for the sub-range of the at least one other of the acoustic emission sensor signals. In particular, a greater leakage rate is preferably determined the greater the value of the respective characteristic number, which was determined for the sub-range of the first acoustic emission sensor signal, is greater than the value of the respective characteristic number, which was determined for the sub-range of the at least one other of the acoustic emission sensor signals.

As an alternative to these variants, however, it is also possible for the acoustic emission sensor signals not to be analysed over a sub-range of the frequency range over which the acoustic emission signals are detected in order to establish the diagnosis the component, but that in order to establish the diagnosis of the component, the acoustic emission sensor signals are analysed over the entire frequency range over which the acoustic emission signals are detected.

Preferably, the acoustic emission sensor signals are analysed to establish the diagnosis of the component by determining a value of the at least one characteristic number for at least two mutually offset area sections, particularly preferably at least ten mutually offset area sections, very particularly preferably at least twenty mutually offset area sections, of the frequency range of the respective acoustic emission sensor signal over which frequency range the respective acoustic emission signal is detected. If, as explained above, the acoustic emission sensor signals are evaluated over a sub-range of the frequency range over which the acoustic emission sensor signals are detected in order to establish the diagnosis of the component by determining at least one characteristic number of the respective acoustic emission sensor signal for this sub-range, the at least two or at least ten or at least twenty offset area sections of the frequency range are preferably contained in the sub-range. Accordingly, the acoustic emission sensor signals are preferably analysed to establish the diagnosis of the component by determining a value of the at least one characteristic number for at least two mutually offset area sections, particularly preferably at least ten mutually offset area sections, very particularly preferably at least twenty mutually offset area sections, of the sub-range of the frequency range of the respective acoustic emission sensor signal, over which frequency range the respective acoustic emission signal is detected.

Regardless of whether the at least two or at least ten or at least twenty mutually offset area sections of the frequency range are included in the sub-range or not, this has the advantage that the values of the at least one characteristic number for the various area sections enable a more reliable determination of differences between the various acoustic emission sensor signals, thereby enabling a more reliable diagnosis of the component. Thereby, it is irrelevant whether the at least two or at least ten or at least twenty offset area sections are disjoint or partially overlapping.

Particularly preferably, the at least two or at least ten or at least twenty area sections offset from one another all have the same width. In a variant to this, however, the at least two or at least ten or at least twenty area sections offset from one another can also have different widths.

Particularly preferably, the neighbouring of the at least two or at least ten or at least twenty area sections that are offset from one another are each offset from one another by the same amount. In a variant to this, however, the area sections closest to one another of the at least two or at least ten or at least twenty offset sections can also each be offset from one another by a different offset.

If the medium is water, the area sections preferably have a width in the range from 10 kHz to 25 kHz. In a preferred variant, each of the at least two or at least ten or at least twenty area sections that are neighbouring to each other are offset from each other by an offset that is in the range from 1 kHz to 10 kHz, particularly preferably in the range from 2 kHz to 5 kHz. However, the area sections can also have a width that is not in the range of 10 kHz to 25 kHz. The offset between the area sections neighbouring to each other can also be less than 1 kHz or greater than 25 kHz.

Advantageously, the diagnosis of the component is established taking into account the first acoustic emission sensor signal and at least two further acoustic emission sensor signals, with the first position along the flow path being located between the two positions at which two of the at least two further acoustic emission signals have been detected. Thereby, preferably, a classification is carried out either on the basis of one of the at least one characteristic number for each of the at least two or at least ten or at least twenty area sections, in that the respective area section is classified as belonging to a first class precisely when a condition is fulfilled for the one of the at least one characteristic number, according to which condition the one of the at least one characteristic number has a value determined for the respective area section of the first acoustic emission sensor signal, which value is greater by at least one classification threshold value than the value determined for the respective area section of the one of the two of the at least two further of the acoustic emission sensor signals and is greater by at least the classification threshold value than the value determined for the respective area section of the other of the two of the at least two further of the acoustic emission sensor signals, or wherein a classification is carried out on the basis of the one of the at least one characteristic number for each of the at least two or at least ten or at least twenty area sections by classifying the respective area section as belonging to the first class precisely when a condition is fulfilled for the one of the at least one characteristic number, according to which condition the one of the at least one characteristic number has a value determined for the respective area section of the first sound emission sensor signal, which value is smaller by at least the classification threshold value than the value determined for the respective area section of the one of the two of the at least two further acoustic emission sensor signals and is smaller by at least the classification threshold value than the value determined for the respective area section of the other of the two of the at least two further acoustic emission sensor signals.

This classification of certain area sections as belonging to the first class has the advantage that, based on the number or proportion of the area sections classified as belonging to the first class, a more reliable determination of the differences between the first acoustic emission sensor signal and the two of the at least two further acoustic emission sensor signals is made possible. Since the first position along the flow path is located between the two positions at which the two of the at least two other acoustic emission signals have been detected, noise caused by sources located away from the first position and thus away from the component for which the diagnosis is being established can be masked out particularly efficiently, since only area sections in which the noise is not present in the detected acoustic emission signals or at least only plays a subordinate role are classified as belonging to the first class. Accordingly, this enables establishing a more reliable diagnosis of the component.

Preferably, the respective area section is classified as belonging to the first class if a difference between the value of the characteristic number determined for the respective area section of the first acoustic emission sensor signal and the values of the characteristic number determined for the respective area section of the two of the at least two other acoustic emission sensor signals indicates a defective component. Depending on the definition of one of the at least one characteristic number, a value of the characteristic number determined for the respective area section of the first acoustic emission sensor signal which is greater by at least the classification threshold value than the values of the characteristic number determined for the respective area section of the two of the at least two further acoustic emission sensor signals indicates a defective component or a value of the characteristic number determined for the respective area section of the first acoustic emission sensor signal, which is smaller by at least the classification threshold value than the values of the characteristic number determined for the respective area section of the two of the at least two other acoustic emission sensor signals indicates a defective component. If the one of the at least one characteristic number is, for example, as already mentioned above, the root mean square (RMS_{area section}) of the respective acoustic emission sensor signal within the respective area section, where this root mean square (RMS_{area section}) is calculated according to the formula

$${RMS}_{area section} = \sqrt{\frac{1}{p} {Σ}_{i = 1}^{p} {f}_{i}^{2}} ,$$

where p is the number of data points in the area section and fᵢ is the value of the i^{th} data point in the area section, then the respective area section is preferably classified as belonging to the first class if the value of the root mean square RMS_{area section} determined for the respective area section of the first acoustic emission sensor signal is greater by at least the classification threshold value than the value of the root mean square RMS_{area section} determined for the respective area section of the two of the at least two further acoustic emission sensor signals.

In all these variants, the classification threshold value can be a constant value. However, in all these variants, the classification threshold value may also be a relative value. For example, the classification threshold value can be a percentage of the value of the one of the at least one characteristic number, which value is determined for the respective area section for the respective one of the two of the at least two further acoustic emission sensor signals and is compared for the classification with the value of the one of the at least one characteristic number determined for the respective area section of the first acoustic emission sensor signal. The percentage can be 10%, 15%, 20% or 25%, for example.

If a pressure difference, in particular a pressure drop, in the pipeline across the component installed in the pipeline is taken into account for the diagnosis of the component, the classification threshold value is selected, for example, as a function of the pressure difference. If, for example, the pressure difference in the pipeline across the component installed in the pipeline is less than 0.5 bar, the classification threshold value is preferably 15% of the value of the one of the at least one characteristic number, which value is determined for the respective area section for the respective one of the two of the at least two further sound emission sensor signals and is compared for the classification with the value of the one of the at least one characteristic number determined for the respective area section of the first sound emission sensor signal. If, on the other hand, the pressure difference in the pipeline across the component installed in the pipeline is 0.5 bar or more, for example, the classification threshold value is preferably 25% of the value of the one of the at least one characteristic number, which value is determined for the respective area section for the respective one of the two of the at least two further acoustic emission sensor signals and is compared for the classification with the value of the one of the at least one characteristic number determined for the respective area section of the first acoustic emission sensor signal.

Preferably, if a proportion of the at least two or at least ten or at least twenty area sections has been classified as belonging to the first class, which proportion is greater than a quota threshold value, the component is diagnosed as defective as a diagnosis of the component. If, on the other hand, less than the quota threshold value of the at least two or at least ten or at least twenty area sections have been classified as belonging to the first class, the valve is diagnosed as not defective and therefore as intact. This has the advantage of enabling a very reliable establishing of the diagnosis of the component.

Preferably, the quota threshold value is at least 2% of the at least two or at least ten or at least twenty area sections, particularly preferably at least 3% of the at least two or at least ten or at least twenty area sections, very particularly preferably at least 5% of the at least two or at least ten or at least twenty area sections. In a variant thereto, however, the second quota threshold value can also be less than 2% of the at least two or at least ten or at least twenty area sections.

Advantageously, the diagnosis of the component is established by an evaluation method based on supervised machine learning. This has the advantage that with increasing training data, a more reliable and precise diagnosis of the component is made possible in a simple manner.

Preferably, supervised machine learning is achieved by training an algorithm with training data. The training data preferably includes data recorded on a test stand. The training data may, for example, have been recorded using the arrangement described below. However, the training data can also include data recorded on one or more pipelines, in which pipelines a component is installed, for which component a diagnosis has been established using the method according to the invention. However, the diagnosis of the component is preferably verified subsequently, for example by removing and examining the component, so that the condition of the test component or component to which the respective acoustic emission sensor signals belong is known and thus information on the diagnosis of the component assigned to the respective acoustic emission sensor signals is included in the training data.

The test stand preferably comprises a test pipeline with a test component installed therein, in particular a test valve, wherein the test pipeline is preferably similar in construction to pipelines on which the diagnosis is to be established for a component installed therein using the method according to the invention, while the test component is preferably similar in construction, particularly preferably identical in construction, to the component for which the diagnosis is to be established using the method according to the invention. For example, the test component can be a valve of the same type as the valve for which the diagnosis is to be established using the method according to the invention.

The training data advantageously comprises a plurality of training data sets, each training data set preferably containing a first training acoustic emission sensor signal and a second training acoustic emission sensor signal and, if applicable, a third training acoustic emission sensor signal, if applicable a fourth training acoustic emission sensor signal and, if applicable, a fifth training acoustic emission sensor signal. These training acoustic emission sensor signals are preferably output by the at least one acoustic emission sensor and correspond to the acoustic emission signal detected by the respective at least one acoustic emission sensor at the first position or second position or third position or fourth position or fifth position, in particular on the outside of the test pipeline. In the case of training data recorded on one or more pipelines when using the method according to the invention, the respective training acoustic emission sensor signal is thus preferably the respective acoustic emission sensor signal, while in the case of training data recorded on the test stand, the respective training acoustic emission sensor signal preferably corresponds to the acoustic emission signal recorded at the respective position on the test pipeline, in particular on the outside of the test pipeline. In other words, the training acoustic emission sensor signals recorded on the test stand are preferably recorded in the same way as the acoustic emission sensor signals described above were recorded on the pipeline, in particular on the outside of the pipeline.

Preferably, the training acoustic emission sensor signals are frequency-resolved in frequency space for supervised machine learning using the resulting Fast Fourier Transform. If the acoustic emission sensor signals or training acoustic emission sensor signals are output with time resolution by the at least one acoustic emission sensor, a Fast Fourier Transform is preferably calculated from each time-resolved training acoustic emission sensor signal, with the resulting Fast Fourier Transform being used in each case for the monitored machine learning. Preferably, the frequency-resolved training sound emission sensor signals or the Fast Fourier Transforms are smoothed before they are used for the supervised machine learning. For this purpose, they can be convolved with a Gaussian curve, for example.

Preferably, each training data set also contains the state of the test component or component to which the training acoustic emission sensor signals of the respective training data set belong, and thus information on the diagnosis of the test component or component associated with the training acoustic emission sensor signals of the respective training data set. The test data contains a classification of the training acoustic emission sensor signals with the information on the diagnosis of the test component or the component assigned to the training acoustic emission sensor signals of the respective training data set.

If the respective training data set was recorded on the test stand and the test component used is a leaking test valve, the respective training data set also preferably contains the leakage rate of the test valve determined on the test stand.

If the respective training data set has been recorded on the test bench, each training data set preferably contains for each training acoustic emission sensor signal, i.e. for the first training acoustic emission sensor signal, the second training acoustic emission sensor signal, possibly the third training acoustic emission sensor signal, possibly the fourth training acoustic emission sensor signal and possibly the fifth training acoustic emission sensor signal, a coupling strength of the respective one of the at least one acoustic emission sensor at the respective position on the test pipeline, in particular on the outside of the test pipeline, i.e. at the first position, at the second position, at the third position, at the fourth position and at the fifth position, when detecting the respective acoustic emission signal, to which acoustic emission signal the respective training acoustic emission sensor signal corresponds.

Preferably, for this, before the respective acoustic emission signal is detected with the one of the at least two acoustic emission sensors with which the respective acoustic emission signal has been detected at the respective position on the test pipeline, in particular on the outside of the test pipeline, i.e. at the first position, at the second position, possibly at the third position, possibly at the fourth position or possibly at the fifth position, the respective acoustic emission sensor is positioned at the respective position on the test pipeline, in particular on the outside of the test pipeline, and an acoustic coupling of the respective acoustic emission sensor to the test pipeline is checked at the respective position on the test pipeline, in particular on the outside of the test pipeline.

At least two acoustic emission sensors are preferably used for this purpose. Preferably, in addition to the respective one of the at least two acoustic emission sensors being positioned at the respective position on the test pipeline, in particular on the outside of the test pipeline, a further one of the at least two acoustic emission sensors is positioned at a position on the test pipeline neighbouring the respective position, in particular on the outside of the test pipeline, whereafter the test sound signal is output by the other of the at least two sound emission sensors, while the test sound signal is detected by the sound emission sensor whose acoustic coupling to the test pipe is been checked. Based on the test acoustic signal detected by the respective acoustic emission sensor, a reception strength and thus a coupling strength of the test acoustic signal detected by the respective acoustic emission sensor is preferably determined. If the determined reception strength or the coupling strength was below a predetermined minimum strength, the respective acoustic emission sensor is preferably repositioned at the respective position and its acoustic coupling to the test pipe is checked until the determined reception strength or coupling strength has at least corresponded to the predetermined minimum strength. Advantageously, the respective acoustic emission signal is only detected with the respective acoustic emission sensor and the training acoustic emission sensor signal corresponding to the respective detected acoustic emission signal is only output by the respective acoustic emission sensor once the reception strength or coupling strength determined for the respective acoustic emission sensor at the respective position has corresponded to at least the specified minimum strength.

Preferably, each training data set also contains information on the aggregate state of the fluid and/or the medium of the fluid to which the training acoustic emission sensor signals of the respective training data set belong.

Preferably, each training data set further contains information on a pressure difference, in particular pressure drop, in the test pipe or pipeline, across the test component or component installed in the test pipe or pipeline.

The pressure difference in the test pipeline or pipeline across the test component or component installed in the test pipeline or pipeline is preferably a difference between a pressure under which the fluid is at a first point in the test pipeline or pipeline as seen from the test component or component along the flow path against the direction of flow just adjacent to the test component or component, and a pressure under which the fluid is at a second point in the test pipeline or pipeline as seen from the test component or component along the flow path against the direction of flow. If the test component or component is a test valve, the pressure difference is preferably a pressure drop seen in the flow guiding direction. If, on the other hand, the test component is a pump, the pressure difference in the flow guiding direction can also be an increase in pressure. Preferably, the pressure difference is determined by a pressure measurement at the first point and by a pressure measurement at the second point, with the difference between the two pressure measurements being the pressure difference.

Advantageously, each training data set also contains information on the test component or component, wherein, if the test component or component is a test valve or valve, the information includes information on the valve type.

Advantageously, each training data set also contains information on a size of the test component or component, in particular an internal diameter, wherein, if the test component or component is a valve or test valve, the information contains information on a nominal size of the valve or test valve as the size of the test component or component.

Preferably, the training acoustic emission sensor signals are each evaluated in the training data sets as described above for the acoustic emission sensor signals over a sub-range of the frequency range over which the training acoustic emission signals are detected, in that at least one characteristic number of the respective acoustic emission sensor signal is determined for this sub-range, with the respective resulting value of the characteristic number being used as a component of the respective training data set. The sub-range can be shifted according to the conditions described above.

Advantageously, the training data comprises at least 40 training data sets, preferably at least 100 training data sets, particularly preferably at least 500 training data sets. Preferably, the training data includes at least 40 training data sets for each state of the test component. Particularly preferably, the training data for each test component or component contains at least 40 training data sets for each state. Very preferably, the training data for each test component or component contains at least 40 training data sets for each medium for each state.

As already mentioned, supervised machine learning is preferably achieved by training an algorithm with training data. Preferably, this algorithm is based on a random forest approach or a custom-designed neural network approach. Alternatively, the algorithm can also be based on a different approach.

According to the invention, the method described above for establishing a diagnosis of a component is used in a method for diagnosing a component. This is a method for diagnosing a component, in particular a valve, by means of acoustic emission examination, which component is installed in a pipeline, which pipeline is designed for guiding a fluid along a flow path in a flow guiding direction. The first acoustic emission signal is detected by one of at least one acoustic emission sensor at a first position on the pipeline, in particular on the outside of the pipeline, and the first acoustic emission sensor signal corresponding to the detected first acoustic emission signal is output by the one of the at least one acoustic emission sensor by which the first acoustic emission signal is detected at the first position on the pipeline, in particular on the outside of the pipeline. Furthermore, the second acoustic emission signal is detected by one of the at least one acoustic emission sensor at a second position on the pipeline, in particular on the outside of the pipeline, and the second acoustic emission sensor signal corresponding to the second acoustic emission signal is output by that of the at least one acoustic emission sensor with which the second acoustic emission signal is detected at the second position on the pipeline, in particular on the outside of the pipeline. The first acoustic emission sensor signal is transmitted to a diagnostic module which is connected to the one of the at least one acoustic emission sensor with which the first acoustic emission signal has been detected in order to establish the diagnosis of the component, and the second acoustic emission sensor signal is transmitted to the diagnostic module which is connected to the one of the at least one acoustic emission sensor with which the second acoustic emission signal has been detected for establishing the diagnosis of the component, and the diagnosis of the component is established by means of the diagnostic module, taking into account the first acoustic emission sensor signal and the second acoustic emission sensor signal, using the method according to the invention described above for establishing a diagnosis of a component.

The acoustic emission sensor used to detect the second acoustic emission signal at a second position on the pipeline, in particular on the outside of the pipeline, can be the same acoustic emission sensor used to detect the first acoustic emission signal at the first position on the pipeline or can be a different acoustic emission sensor.

Preferably, the diagnostic module is formed by the computer program product described above for carrying out the method for establishing a diagnosis of a component with the method for establishing a diagnosis of a component.

Advantageously, the third acoustic emission signal is detected by one of the at least one acoustic emission sensor at the third position on the pipeline, in particular on the outside of the pipeline, and the third acoustic emission sensor signal corresponding to the third acoustic emission signal is output by the one of the at least one acoustic emission sensor with which the third acoustic emission signal is detected at the third position on the pipeline, in particular on the outside of the pipeline, the third acoustic emission sensor signal being transmitted to the diagnostic module which is connected to that of the at least one acoustic emission sensor with which the third acoustic emission signal has been detected, for the purpose of establishing the diagnosis of the component, and the diagnosis of the component is established by means of the diagnostic module, taking additionally into account the third acoustic emission sensor signal, using the method for establishing a diagnosis of a component.

Preferably, the fourth acoustic emission signal is detected by one of the at least one acoustic emission sensor at the fourth position on the pipeline, in particular on the outside of the pipeline, and the fourth acoustic emission sensor signal corresponding to the fourth acoustic emission signal is output by the one of the at least one acoustic emission sensor with which the fourth acoustic emission signal is detected at the fourth position on the pipeline, in particular on the outside of the pipeline, the fourth acoustic emission sensor signal being transmitted to the diagnostic module which is connected to that of the at least one acoustic emission sensor with which the fourth acoustic emission signal has been detected, for the purpose of establishing the diagnosis of the component, and the diagnosis of the component is established by means of the diagnostic module, taking additionally into account the fourth acoustic emission sensor signal, using the method according to the invention for establishing a diagnosis of a component. Preferably, the fifth acoustic emission signal is detected by one of the at least one acoustic emission sensor at the fifth position on the pipeline, in particular on the outside of the pipeline, and the fifth acoustic emission sensor signal corresponding to the fifth acoustic emission signal is output by the one of the at least one acoustic emission sensor with which the fifth acoustic emission signal is detected at the fifth position on the pipeline, in particular on the outside of the pipeline, wherein the fifth acoustic emission sensor signal is transmitted to the diagnostic module which is connected to that of the at least one acoustic emission sensor with which the fifth acoustic emission signal has been detected, for establishing the diagnosis of the component, and the diagnosis of the component is established by means of the diagnostic module with additional consideration of the fifth acoustic emission sensor signal using the method according to the invention for establishing a diagnosis of a component.

If the component is a valve, at least one acoustic emission sensor preferably detects the first acoustic emission signal and the second acoustic emission signal and, if applicable, the third acoustic emission signal, if applicable the fourth acoustic emission signal and, if applicable, the fifth acoustic emission signal when the valve is closed.

Advantageously, the at least one acoustic emission sensor is at least two acoustic emission sensors. Advantageously, a test acoustic signal can be output with at least one of the at least two acoustic emission sensors, in particular within the frequency range over which the acoustic emission signals are detected with the at least two acoustic emission sensors. In a particularly preferred variant, the acoustic test signal has a frequency that corresponds to a natural frequency of the at least two acoustic emission sensors. In a variant thereof, the acoustic test signal only comprises the frequency corresponding to the natural frequency of the at least two acoustic emission sensors. Regardless of whether the acoustic test signal has a frequency which corresponds to the natural frequency of the at least two acoustic emission sensors or not, in another particularly preferred variant the acoustic test signal has a frequency spectrum which extends over the entire frequency range over which the acoustic emission signals are detected with the at least two acoustic emission sensors. The frequency spectrum can be a continuous or a discrete frequency spectrum.

Advantageously, before the respective acoustic emission signal is detected at the respective position on the pipeline, in particular on the outside of the pipeline, the respective acoustic emission sensor is positioned at the respective position on the pipeline, in particular on the outside of the pipeline, i.e. at the first position, at the second position, possibly at the third position, possibly at the fourth position or possibly at the fifth position, and an acoustic coupling of the respective acoustic emission sensor to the pipeline is checked with the one of the at least two acoustic emission sensors with which the respective acoustic emission signal is detected at the respective position on the pipeline, in particular on the outside of the pipeline. For this purpose, in addition to the respective acoustic emission sensor being positioned at the respective position on the pipeline, in particular on the outside of the pipeline, a further one of the at least two acoustic emission sensors is preferably positioned at a position neighbouring the respective position on the pipeline, in particular on the outside of the pipeline, after which the acoustic test signal is output with the further one of the at least two acoustic emission sensors, while the acoustic test signal is detected with the acoustic emission sensor whose acoustic coupling to the pipeline is being checked. Based on the acoustic test signal detected by the respective acoustic emission sensor, a reception strength and thus a coupling strength of the acoustic test signal detected by the respective acoustic emission sensor is then preferably determined. If the determined reception strength or the coupling strength is below a predetermined minimum strength, the respective acoustic emission sensor is preferably repositioned at the respective position and its acoustic coupling to the pipeline is checked until the determined reception strength or coupling strength corresponds to at least the predetermined minimum strength. Advantageously, the respective acoustic emission signal is not detected with the respective acoustic emission sensor until the reception strength or coupling strength determined for the respective acoustic emission sensor at the respective position corresponds to at least the specified minimum strength, and the acoustic emission signal corresponding to the respective detected acoustic emission signal is output by the respective acoustic emission sensor. The received strength or coupling strength can be a scalar value or can be a frequency-dependent function. I.e. in the latter case, the received strength can have a different value for each frequency in the acoustic test signal. However, as an alternative to these variants with at least two acoustic emission sensors, the at least one acoustic emission sensor is a single acoustic emission sensor.

According to the invention, an arrangement for carrying out the method for diagnosing a component, in particular a valve, by means of acoustic emission examination, which component is installed in a pipeline, which pipeline is designed for guiding a fluid along a flow path in a flow guiding direction, comprises at least one acoustic emission sensor for detecting a first acoustic emission signal at a first position on a pipeline, in particular on the outside of the pipeline, and outputting a first acoustic emission sensor signal, wherein the first acoustic emission sensor signal corresponds to the detected first acoustic emission signal, for detecting a second acoustic emission signal at a second position on the pipeline, in particular on the outside of the pipeline, and outputting a second acoustic emission sensor signal, the second acoustic emission sensor signal corresponding to the detected second acoustic emission signal, possibly a third acoustic emission signal at a third position on the pipeline, in particular on the outside of the pipeline, and outputting a third acoustic emission sensor signal, the third acoustic emission sensor signal corresponding to the detected third acoustic emission signal, possibly a fourth acoustic emission signal at a fourth position on the pipeline, in particular on the outside of the pipeline, and outputting a third acoustic emission sensor signal, the fourth acoustic emission sensor signal corresponding to the detected fourth acoustic emission signal, possibly a fifth acoustic emission signal at a fifth position on the pipeline, in particular on the outside of the pipeline, and outputting a fifth acoustic emission sensor signal, the fifth acoustic emission sensor signal corresponding to the detected fifth acoustic emission signal, and a diagnostic unit with the diagnostic module for establishing the diagnosis of the component, taking into account the first acoustic emission sensor signal and the second acoustic emission sensor signal, the diagnosis of the component using the method according to the invention, wherein the diagnostic unit with the diagnostic module is connected to the one of the at least one acoustic emission sensor with which the first acoustic emission signal is to be detected for receiving the first acoustic emission sensor signal, to the one of the at least one acoustic emission sensor with which the second acoustic emission signal is to be detected for receiving the second acoustic emission sensor signal, possibly to the one of the at least one acoustic emission sensor with which the third acoustic emission signal is to be detected for receiving the third acoustic emission sensor signal, possibly to the one of the at least one acoustic emission sensor with which the fourth acoustic emission signal is to be detected for receiving the fourth acoustic emission sensor signal, and possibly to the one of the at least one acoustic emission sensor with which the fifth acoustic emission signal is to be detected for receiving the fifth acoustic emission sensor signal.

If the acoustic emission sensor signals are prefiltered with a prefilter in the method for establishing the diagnosis of a component as described above, then the diagnostic module preferably comprises a prefilter module for prefiltering the acoustic emission sensor signals. In one variant, however, the pre-filter module can also be designed separately from the diagnostic module. For example, the arrangement can include the pre-filter module, but the pre-filter module is not part of the diagnostic module.

As an alternative to these variants, however, it is also possible for the arrangement to be designed without the pre-filter module.

The diagnostic unit can be formed by a smartphone, for example, on which the diagnostic module is installed in the form of a computer programme product. This has the advantage that the diagnostic unit can be brought to the location of the component for which the diagnosis is to be established without great effort. However, the diagnostic unit can also be formed by another computer unit, such as a personal computer, on which the diagnostic module is installed in the form of a computer program product. However, the diagnostic unit can also be formed by several computers and thus, for example, be formed by a cloud on which the diagnostic module is installed in the form of a computer program product.

Preferably, the at least one acoustic emission sensor has a magnet for attaching the at least one acoustic emission sensor to the pipeline, in particular to the outside of the pipeline, and for holding the at least one acoustic emission sensor in place on the pipeline. This has the advantage that the at least one acoustic emission sensor can be attached to the pipeline, in particular to the outside of the pipeline, in a simple manner with a reproducible force. Alternatively, however, it is also possible that the at least one acoustic emission sensor does not have a magnet for attaching the at least one acoustic emission sensor to the pipeline and for holding the at least one acoustic emission sensor on the pipeline. For example, the at least one acoustic emission sensor can simply be attached and held in place on the pipeline by hand.

Preferably, the arrangement comprises at least two acoustic emission sensors. This has the advantage that the coupling strength of the acoustic emission sensors can be determined in a simple and reliable manner as described above and used to diagnose the component.

Alternatively, however, it is also possible for the arrangement to comprise only one acoustic emission sensor.

Further advantageous embodiments and combinations of features of the invention result from the following detailed description and the entirety of the patent claims.

### BRIEF DESCRIPTION OF THE DRAWINGS

The drawings used to illustrate the embodiment example show:

FIG. 1 a simplified schematic representation of an arrangement for carrying out a method according to the invention for diagnosing a component, in particular a valve, by means of acoustic emission examination, which component is installed in a pipeline, which pipeline is designed for guiding a fluid along a flow path in a flow guiding direction,

FIG. 2 curves of a first acoustic emission sensor signal, a second acoustic emission sensor signal and a third acoustic emission sensor signal over the frequency range from 25 kHz to 350 kHz of a first measurement for establishing a diagnosis of a valve,

FIG. 3 curves of the first acoustic emission sensor signal, the second acoustic emission sensor signal and the third acoustic emission sensor signal over the frequency range from 25 kHz to 350 kHz of a second measurement for establishing a diagnosis of the valve,

FIG. 4 curves of the first acoustic emission sensor signal, the second acoustic emission sensor signal and the third acoustic emission sensor signal over the frequency range from 25 kHz to 350 kHz of a third measurement for establishing a diagnosis of the valve,

FIG. 5 curves of the first acoustic emission sensor signal, the second acoustic emission sensor signal and the third acoustic emission sensor signal over the frequency range from 25 kHz to 350 kHz of a fourth measurement for establishing a diagnosis of another valve,

FIG. 6 curves of the first acoustic emission sensor signal, the second acoustic emission sensor signal and the third acoustic emission sensor signal over the frequency range from 25 kHz to 350 kHz of a fifth measurement for establishing a diagnosis of another valve,

FIG. 7 a simplified schematic representation of a further pipeline which is designed to conduct a fluid along a flow path in a flow path direction and in which a valve is installed as a component, on which valve the method according to the invention for diagnosing a component or valve by means of acoustic emission examination can be carried out,

FIG. 8 an illustration of how, using the method according to the invention, the detected acoustic emission signals can be reproduced time-resolved and prefiltered, wherein for prefiltering, the respective time-resolved acoustic emission sensor signal is divided into sections,

FIG. 9 an acoustic emission sensor signal shown in frequency space to illustrate the further processing of the pre-filtered acoustic emission sensor signals by evaluating the respective pre-filtered acoustic emission sensor signal in different area sections of the respective pre-filtered acoustic emission sensor signal,

FIG. 10 three pre-filtered acoustic emission sensor signals to illustrate how the diagnosis of the valve can be established using the method according to the invention, taking into account the first acoustic emission sensor signal, the second acoustic emission sensor signal and the third acoustic emission sensor signal, by first obtaining an intermediate result by classifying the area sections of the acoustic emission sensor signals on the basis of determined values of the respective root mean square, and

FIG. 11 a graph of the determined values of the root mean square for the different area sections of the three acoustic emission sensor signals to illustrate the further procedure for establishing the diagnosis of the valve.

In general, identical parts are labelled with identical reference symbols in the figures.

### Ways of Implementing the Invention

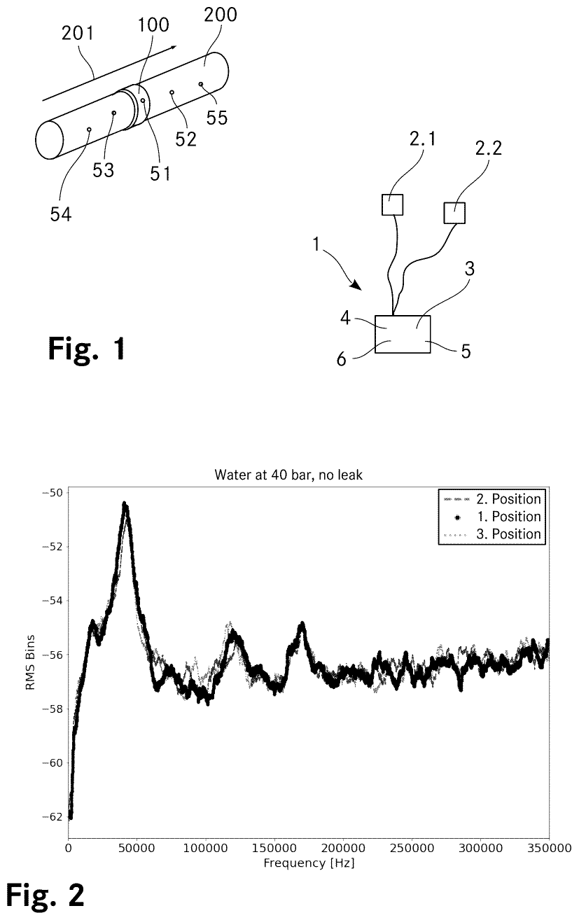

FIG. 1 shows a simplified schematic representation of an arrangement 1 for carrying out a method according to the invention for diagnosing a component 100, in particular a valve, by means of acoustic emission examination, which component 100 is installed in a pipeline 200, which pipeline 200 is designed for guiding a fluid along a flow path in a flow guiding direction 201. The arrangement 1 comprises two acoustic emission sensors 2.1, 2.2 for detecting acoustic emission signals in a frequency range from 25 kHz to 350 kHz and outputting acoustic emission sensor signals which correspond to the respective detected acoustic emission signal. In variants, it is also possible to use the two acoustic emission sensors 2.1, 2.2 to detect the respective acoustic emission signal not over the frequency range of 25 kHz to 350 kHz specified above, but over a frequency range of approximately 1 kHz to approximately 1 MHZ, from 1 kHz to 1 MHZ, 25 kHz to 500 kHz, or from 25 kHz to 300 kHz. Thereby, the acoustic emission signals output by the respective acoustic emission sensor also cover the frequency range corresponding to the respective variant from about 1 kHz to about 1 MHz, from 1 kHz to 1 MHz, or from 25 kHz to 500 kHz, or from 25 kHz to 350 kHz, or from 25 kHz to 300 kHz.

The two acoustic emission sensors 2.1, 2.2 each have a magnet for attaching the at least respective acoustic emission sensor 2.1, 2.2 to the outside of the pipeline 200 and for holding the respective acoustic emission sensor 2.1, 2.2 to the pipeline 200. Both acoustic emission sensors 2.1, 2.2 can also be used to output an acoustic test signal at 50 kHz, which is a natural frequency of the acoustic emission sensors 2.1, 2.2. However, the acoustic test signal can also have one or more frequencies other than 50 kHz. For example, the acoustic test signal can be in the range from 1 kHz to 1 MHZ, in the range from 20 kHz to 500 kHz, or in the range from 50 kHz 200 KHz.

The arrangement 1 thus comprises at least one acoustic emission sensor 2.1, 2.2 for detecting a first acoustic emission signal at a first position 51 on the pipeline 200 and outputting a first acoustic emission sensor signal, wherein the first acoustic emission sensor signal corresponds to the detected first acoustic emission signal, for detecting a second acoustic emission signal at a second position 52 on the pipeline 200 and outputting a second acoustic emission sensor signal, wherein the second acoustic emission sensor signal corresponds to the detected second acoustic emission signal, for detecting a third acoustic emission signal at a third position 53 on the pipeline 200 and outputting a third acoustic emission sensor signal, wherein the third acoustic emission sensor signal corresponds to the detected third acoustic emission signal, for detecting a fourth acoustic emission signal at a fourth position 54 on the pipeline 200 and outputting a fourth acoustic emission sensor signal, wherein the fourth acoustic emission sensor signal corresponds to the detected fourth acoustic emission signal, and for detecting a fifth acoustic emission signal at a fifth position 55 on the pipeline 200 and outputting a fifth acoustic emission sensor signal, wherein the fifth acoustic emission sensor signal corresponds to the detected fifth acoustic emission signal. The arrangement 1 further comprises a diagnostic unit 3 with the diagnostic module 4 for establishing the diagnosis of the component 100 taking into account the first acoustic emission sensor signal and the second acoustic emission sensor signal with the method according to the invention for establishing a diagnosis of the component 100. The diagnostic unit 3 with the diagnostic module 4 is connected to the acoustic emission sensors 2.1, 2.2 for receiving the acoustic emission sensor signals output by the acoustic emission sensors 2.1, 2.2. The diagnostic unit 3 with the diagnostic unit is thus, for receiving the first acoustic emission sensor signal, connected to the one of the at least one acoustic emission sensor 2.1, 2.2 with which the first acoustic emission signal is to be detected, for receiving the second acoustic emission sensor signal, connected to the one of the at least one acoustic emission sensor 2.1, 2.2 with which the second acoustic emission signal is to be detected, for receiving the third acoustic emission sensor signal, connected to the one of the at least one acoustic emission sensor 2.1, 2.2 with which the third acoustic emission signal is to be detected, for receiving the fourth acoustic emission sensor signal, connected to the one of the at least one acoustic emission sensor 2.1, 2.2 with which the fourth acoustic emission signal is to be detected, and, for receiving the fifth acoustic emission sensor signal, connected to the one of the at least one acoustic emission sensor 2.1, 2.2 with which the fifth acoustic emission signal is to be detected.

In one embodiment, the diagnostic module 4 comprises a prefilter module 6 for prefiltering the acoustic emission sensor signals. In one variant, the arrangement 1 comprises the pre-filter module 6, but the pre-filter module is not part of the diagnostic module. In an alternative to these variants, however, the arrangement can also be designed without the pre-filter module.

In the present embodiment example, the diagnostic unit 3 is a smartphone on which the diagnostic module 4 is installed in the form of a computer program product 5. In a variant thereof, however, the diagnostic unit 3 is formed by another computer unit, such as a personal computer, on which the diagnostic module 4 is installed in the form of a computer program product 5. However, the diagnostic unit 3 can also be formed by several computers and thus, for example, be formed by a cloud on which the diagnostic module 4 is installed in the form of a computer program product 5.

If the arrangement 1 is used to carry out the method according to the invention for diagnosing a component 100, in particular a valve, by means of acoustic emission examination, then in one embodiment the first acoustic emission signal is detected with one of the acoustic emission sensors 2.1, 2.2 at the first position 51 on the outside of the pipeline 200 and the first acoustic emission sensor signal corresponding to the detected first acoustic emission signal is output by the of the at least one acoustic emission sensor 2.1, 2.2 with which the first acoustic emission signal is detected at the first position 51 on the pipeline 200. Furthermore, the second acoustic emission signal is detected by one of the at least one acoustic emission sensor 2.1, 2.2 at the second position 52 on the outside of the pipeline 200 and the second acoustic emission sensor signal corresponding to the second acoustic emission signal is output by the one of the at least one acoustic emission sensor 2.1, 2.2 with which the second acoustic emission signal is detected at the second position 52 on the pipeline 200. In addition, the third acoustic emission signal is detected by one of the at least one acoustic emission sensor 2.1, 2.2 at the third position 53 on the outside of the pipeline 200 and the third acoustic emission sensor signal corresponding to the third acoustic emission signal is output by the one of the at least one acoustic emission sensor 2.1, 2.2 with which the third acoustic emission signal is detected at the third position 53 on the pipeline 200. Furthermore, the fourth acoustic emission signal is detected by one of the at least one acoustic emission sensors 2.1, 2.2 at the fourth position 54 on the outside of the pipeline 200 and the fourth acoustic emission signal corresponding to the fourth acoustic emission signal is output by the one of the at least one acoustic emission sensors 2.1, 2.2 with which the fourth acoustic emission signal is detected at the fourth position 54 on the pipeline 200. In addition, the fifth acoustic emission signal is detected by one of the at least one acoustic emission sensor 2.1, 2.2 at the fifth position 55 on the outside of the pipeline 200 and the fifth acoustic emission sensor signal corresponding to the fifth acoustic emission signal is output by the one of the at least one acoustic emission sensor 2.1, 2.2 with which the fifth acoustic emission signal is detected at the fifth position 55 on the pipeline 200.

Thereby, before the respective acoustic emission signal is detected at each of the positions 51, 52, 53, 54, 55 with the respective one of the at least one acoustic emission sensor 2.1, 2.2, at the respective position 51, 52, 53, 54, 55 on the outside of the pipeline 200, with the respective acoustic emission sensor 2.1, 2.2, with which the respective acoustic emission signal is detected, the respective acoustic emission sensor 2.1, 2.2, with which the respective acoustic emission signal is detected, is positioned at the respective position 51, 52, 53, 54, 55 on the outside of the pipeline 200 and an acoustic coupling of the respective acoustic emission sensor 2.1, 2.2 to the pipeline 200 is checked. For this purpose, in addition to the fact that the respective acoustic emission sensor 2.1, 2.2 is positioned at the respective position 51, 52, 53, 54, 55 on the outside of the pipeline 200, the other acoustic emission sensor 2.2, 2.1 is positioned on the outside of the pipeline 200 at a position neighbouring the respective position 51, 52, 53, 54, 55, after which the other acoustic emission sensor 2.2, 2.1 is used to output the acoustic test signal, while the acoustic test signal is detected by the acoustic emission sensor 2.1, 2.2 whose acoustic coupling to the pipeline 200 is being checked. Based on the acoustic test signal detected by the respective acoustic emission sensor 2.1, 2.2, a reception strength and thus a coupling strength of the acoustic test signal detected by the respective acoustic emission sensor 2.1, 2.2 is then determined. If the determined reception strength or the coupling strength is below a predetermined minimum strength, the respective acoustic emission sensor 2.1, 2.2 is positioned again at the respective position 51, 52, 53, 54, 55 and its acoustic coupling to the pipeline 200 is checked until the determined reception strength or coupling strength corresponds at least to the predetermined minimum strength. Only when the received strength or coupling strength determined for the respective acoustic emission sensor 2.1, 2.2 at the respective position 51, 52, 53, 54, 55 corresponds to at least the specified minimum strength is the respective acoustic emission signal detected by the respective acoustic emission sensor 2.1, 2.2 and the acoustic emission sensor signal corresponding to the respective detected acoustic emission signal output by the respective acoustic emission sensor 2.1, 2.2. In the present embodiment example, the reception strength or coupling strength is a scalar value. However, in a variant, the reception strength or coupling strength can also be a frequency-dependent function. This means that the reception strength can have a different value for each frequency in the acoustic test signal. Regardless of this, the coupling strength is also taken into account in each case for establishing the diagnosis of the component 100.

If the respective acoustic emission signal is detected at the respective positions 51, 52, 53, 54, 55 by the respective acoustic emission sensor 2.1, 2.2 and the acoustic emission sensor signal corresponding to the respective detected acoustic emission signal is output by the respective acoustic emission sensor 2.1, 2.2, the respective acoustic emission signal is continuously detected by the respective at least one acoustic emission sensor 2.1, 2.2 for a period of 2 seconds.

The outputted acoustic emission sensor signals are determined in each case to the diagnostic unit 3 with the diagnostic module 4 and the diagnostic module 4 is used with the method according to the invention for establishing a diagnosis of a component, in particular a valve, by means of acoustic emission examination, which component is installed in the pipeline, which pipeline is designed for guiding a fluid along a flow path in a flow guiding direction, to establish the diagnosis of the component 100.

In the present embodiment, the second position 52 is spaced from the first position 51 in the flow guiding direction on the pipeline 200. Further, along the flow path, the third position 53 is located on a different side of the first position 51 than the second position 52 is located from the first position 51, whereby the first position 51 is located between the second position 52 and the third position 53 when viewed along the flow path. Furthermore, along the flow path, the fourth position 54 is located on a different side of the third position 53 than the first position 51 is located from the third position 53, whereby the third position 53 is located between the first position 51 and the fourth position 54 when viewed along the flow path. Furthermore, along the flow path, the fifth position 55 is located on a different side of the first position 51 than the third position 53 is located from the first position 51, whereby the first position 51 is located between the third position 53 and the fifth position 55 when viewed along the flow path. Furthermore, along the flow path, the fifth position 55 is located on a different side of the second position 52 than the third position 53 is located from the second position 52, whereby the second position 52 is located between the third position 53 and the fifth position 55 along the flow path.

The first acoustic emission sensor signal, the second acoustic emission sensor signal, the third acoustic emission sensor signal, the fourth acoustic emission sensor signal and the fifth acoustic emission sensor signal are taken into account for establishing the diagnosis of the component 100. In a variant of this, however, only the first acoustic emission sensor signal, the second acoustic emission sensor signal, the third acoustic emission sensor signal and the fourth acoustic emission sensor signal are taken into account when establishing the diagnosis of the component 100. In another variant, however, only the first acoustic emission sensor signal, the second acoustic emission sensor signal and the third acoustic emission sensor signal are taken into account when establishing the diagnosis of the component 100. In a further variant, however, only the first acoustic emission sensor signal and the second acoustic emission sensor signal are taken into account when establishing the diagnosis of the component 100.

In the following, the method according to the invention for establishing a diagnosis of a component is explained in connection with the other figures. As an embodiment example, a variant is explained in which only the first acoustic emission signal is detected at the first position 51 on the outside of the pipeline 200, the second acoustic emission signal is detected at the second position 52 on the outside of the pipeline 200 and the third acoustic emission signal is detected at the third position 53 on the outside of the pipeline 200. Therefore, in this embodiment example, only the first acoustic emission sensor signal, the second acoustic emission sensor signal and the third acoustic emission sensor signal are taken into account when establishing the diagnosis of the component 100. However, the fourth acoustic emission sensor signal and the fifth acoustic emission sensor signal explained above are not taken into account, as they have not been recorded at all.

FIG. 2 shows curves of the first acoustic emission sensor signal, the second acoustic emission sensor signal and the third acoustic emission sensor signal over the frequency range from 25 kHz to 350 kHz, which correspond to the first acoustic emission signal detected at the first position 51, the second acoustic emission signal detected at the second position 52 and the acoustic emission signal detected at the third position 53, respectively. The pipeline 200 had an inner diameter of 25 mm and the installed component 100 was a valve, more precisely a ball valve with an inner valve diameter of 25 mm. The fluid in the pipeline 200 was liquid water and was under a pressure of 40 bar above the valve, i.e. seen from the valve against the flow guiding direction 201, while atmospheric pressure, i.e. a pressure of 1 bar, prevailed below the valve, i.e. seen from the valve in the flow guiding direction. This meant that there was a pressure drop of 39 bar across the valve. The closed valve was intact, i.e. tight.

The curves shown in FIG. 2 are each the continuous root mean square according to the formula

$$RMS = \sqrt{\frac{1}{{t}_{2} - {t}_{1}}} {\int }_{{t}_{1}}^{{t}_{2}} {f ( t )}^{2} d t$$

of the Fast Fourier Transformation of the respective acoustic emission sensor signal, where t₂-t₁ corresponds to the width of a bin in the curve, whereby the acoustic emission sensor signals are each corrected with the coupling strength of the acoustic emission sensor 2.1, 2.2, with which the respective acoustic emission signal has been recorded, so that they are comparable with each other.

As can be seen in FIG. 2, the curves of the three acoustic emission sensor signals show very similar curves. A visual assessment of the curves already indicates that the component 100 is intact or the valve is tight and that no or only minor interference noise from sources outside the range from the second position 52 to the third position 53 in the pipeline 200 was also recorded. As the pipeline 200 on which the measurements shown were recorded was a test pipeline, it was also possible to check the valve directly for leaks and ensure that these acoustic emission sensor signals originate from the pipeline with a leak-proof valve.

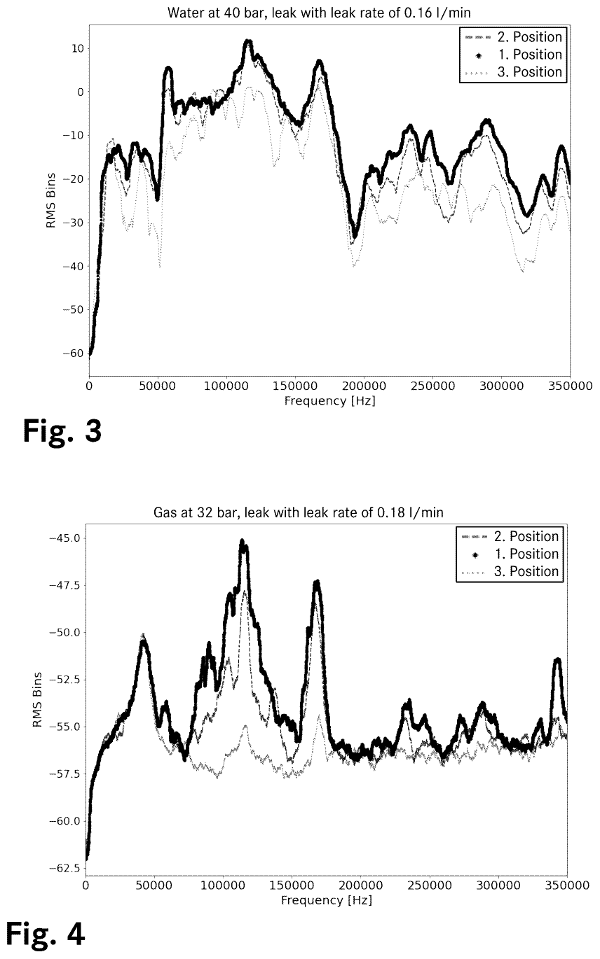

In FIG. 3, analogue to the curves shown in FIG. 2, the curves shown are the first acoustic emission sensor signal, the second acoustic emission sensor signal and the third acoustic emission sensor signal, although in FIG. 3, the closed ball valve has a leakage rate of 0.16 l/min at a water pressure of 40 bar in the same pipeline. As can be seen, the curve of the first acoustic emission sensor signal, which was recorded at the first position 51 at the valve, almost consistently has the highest RMS values, while the curve of the second acoustic emission sensor signal, which has been recorded at the second position 52 as seen from the first position 51 in the flow guiding direction, has a quite similar course to the curve of the first acoustic emission sensor signal below 200 kHz and has slightly lower RMS values than the curve of the first acoustic emission sensor signal above 200 kHz. In contrast, the curve of the third acoustic emission sensor signal, which was recorded at the third position 53 as seen from the first position 51 in the opposite direction to the flow guiding direction, has almost consistently lower RMS values than the curves of the first and second acoustic emission sensor signals. This indicates a leak in the valve.

In FIG. 4, analogue to the curves shown in FIGS. 2 and 3, the curves shown are the first acoustic emission sensor signal, the second acoustic emission sensor signal and the third acoustic emission sensor signal, although in FIG. 4, the fluid was a gas at a pressure of 32 bar and the closed ball valve had a leak with a leakage rate of 0.18 l/min. Here, the different courses of the curves are primarily seen in the sub-range from 50 kHz to 180 kHz, while the course of the curves outside the sub-range are largely similar. Within the sub-range, the curve of the first acoustic emission sensor signal, which was recorded at the first position 51 at the valve, almost consistently has the highest RMS values, while the curve of the second acoustic emission sensor signal, which was recorded at the second position 52 as seen from the first position 51 in the flow guiding direction, has lower RMS values than the curve of the first acoustic emission sensor signal. In contrast, the curve of the third acoustic emission sensor signal, which was recorded at the third position 53 as seen from the first position 51 in the opposite direction to the flow guiding direction, has consistently lower RMS values than the curves of the first and second acoustic emission sensor signals. This indicates a leak in the valve.

However, it should be noted that the curves in FIG. 4 also show these different courses in the sub-ranges from 220 kHz to 250 kHz and from 270 kHz to 300 kHz, albeit to a much lesser extent, which indicates a leak in the valve. Thus, in the example shown in FIG. 4, the sub-range from 50 kHz to 180 kHz is primarily suitable for evaluating the acoustic emission sensor signals for diagnosing the valve. However, if this sub-range is overlaid with interference noise, one or both sub-ranges from 220 kHz to 250 kHz or from 270 kHz to 300 kHz can also be used for the evaluation. How this is done as part of the method according to the invention for establishing a diagnosis of a component is described below:

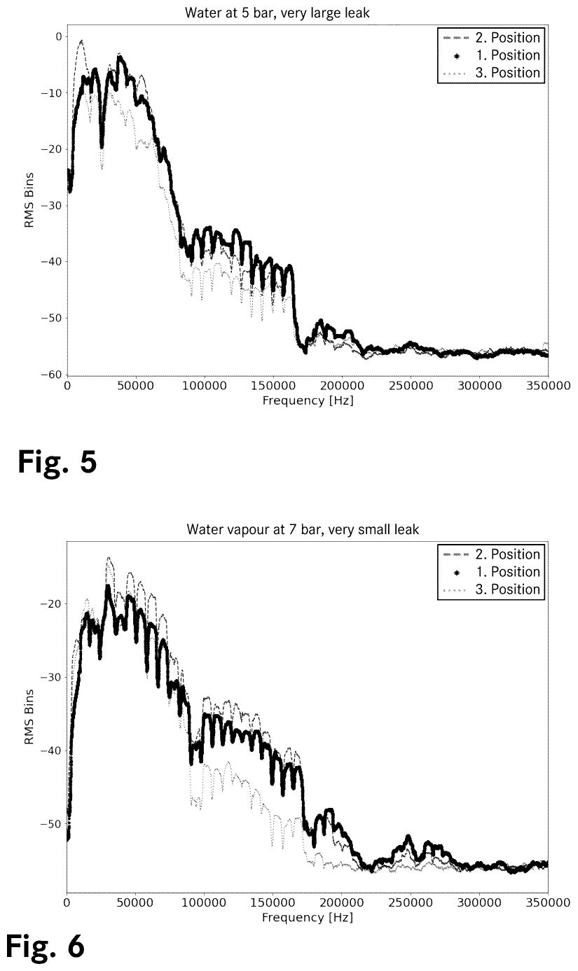

FIG. 5 again shows RMS curves of the first acoustic emission sensor signal, the second acoustic emission sensor signal and the third acoustic emission sensor signal, whereby in FIG. 5, the fluid was water at a pressure above the valve of 5 bar and the pipeline 200 had an internal diameter of 25 mm, but the valve was a globe valve with a valve diameter of 25 mm. In contrast to the previous examples, the acoustic emission signals here were recorded on a pipeline 200 in a production plant. Therefore, the exact leakage rate could not be determined. However, it was known and could be determined using the method according to the invention that the valve had a large leak. It could be determined that a source of strong noise with a frequency of about 10 kHz was present downstream of the second position 52 in the flow guiding direction 201 as seen from the valve.

Since the fluid was liquid water at room temperature, the component 100 or valve was a globe valve and the pressure drop across the valve was 4 bar, a range of 25 kHz to 50 kHz was selected in a first step to establish the diagnosis, in which the root mean square (RMS) of the corrected Fast Fourier Transform was calculated as a characteristic number for each of the acoustic emission sensor signals corrected according to the coupling strength using the formula

$$RMS = \sqrt{\frac{1}{n} {\sum }_{i = 1}^{n} {f}_{i}^{2}} .$$

Subsequently, the characteristic number values determined for the sub-range of each of the three acoustic emission sensor signals were compared with each other. Since the characteristic number determined for the sub-range of the first acoustic emission sensor signal had a value that was between the value determined for the sub-range of the second acoustic emission sensor signal and the value determined for the sub-range of the third acoustic emission sensor signal, it was possible to determine that a source was emitting interference noise in this sub-range that was hindering the establishing the diagnosis of the valve. The sub-range was therefore shifted to higher frequencies, more precisely to the sub-range from 100 kHz to 150 kHz. Then, in a second step, the root mean square (RMS) of the corrected Fast Fourier Transform for each of the acoustic emission sensor signals corrected according to the coupling strength was calculated as a characteristic number in this shifted sub-range using the formula

$$RMS = \sqrt{\frac{1}{n} {\sum }_{i = 1}^{n} {f}_{i}^{2}} .$$

Since the characteristic number determined for this shifted sub-range of the first acoustic emission sensor signal had a value that was not between the value determined for the shifted sub-range of the second acoustic emission sensor signal and the value determined for the shifted sub-range of the third acoustic emission sensor signal, it was possible to determine that only little or no interference noise was detected in this sub-range, which would hinder establishing the diagnosis of the valve. Rather, since the characteristic number determined for the shifted sub-range of the first acoustic emission sensor signal had a value that was greater by at least one threshold value than the value of the characteristic number determined for the sub-range of the second and third acoustic emission sensor signals, the component was diagnosed as defective or the valve was diagnosed as leaking.

FIG. 6 again shows RMS curves of the first acoustic emission sensor signal, the second acoustic emission sensor signal and the third acoustic emission sensor signal, wherein in FIG. 5 the fluid was water vapour at a pressure above the valve of 7 bar and the pipeline 200 had an internal diameter of 150 mm, but the valve had a globe valve with a valve diameter of 150 mm. Here too, the acoustic emission signals were recorded on a pipeline 200 in a production plant. Therefore, the exact leakage rate could not be determined. However, it was known and could be determined using the method according to the invention that the valve had a small leak. It can be seen from the curves shown that, viewed from the valve in the flow guiding direction 201 downstream of the second position 52, there was a source of interference noise with a frequency of approximately 30 kHz to approximately 160 KHz.

The procedure for establishing the diagnosis was very similar to that already described in connection with FIG. 5. However, since the fluid was vapour, the sub-range from 200 kHz to 250 kHz was used in the first step and the characteristic number RMS was determined for this and the values determined for the various acoustic emission sensor signals were compared with each other. Since the characteristic number determined for the sub-range of the first acoustic emission sensor signal had a value that was not between the value determined for the sub-range of the second acoustic emission sensor signal and the value determined for the sub-range of the third acoustic emission sensor signal, it was possible to ensure that only little or no interference noise was detected in this sub-range, which would hinder establishing the diagnosis of the valve. In addition, since the characteristic number determined for the shifted sub-range of the first acoustic emission sensor signal had a value that was just greater by the threshold value than the value of the characteristic number determined for the sub-range of the second and third acoustic emission sensor signals, the component was diagnosed as defective or the valve was diagnosed as leaking, respectively, although it was also determined that the leak was very small.

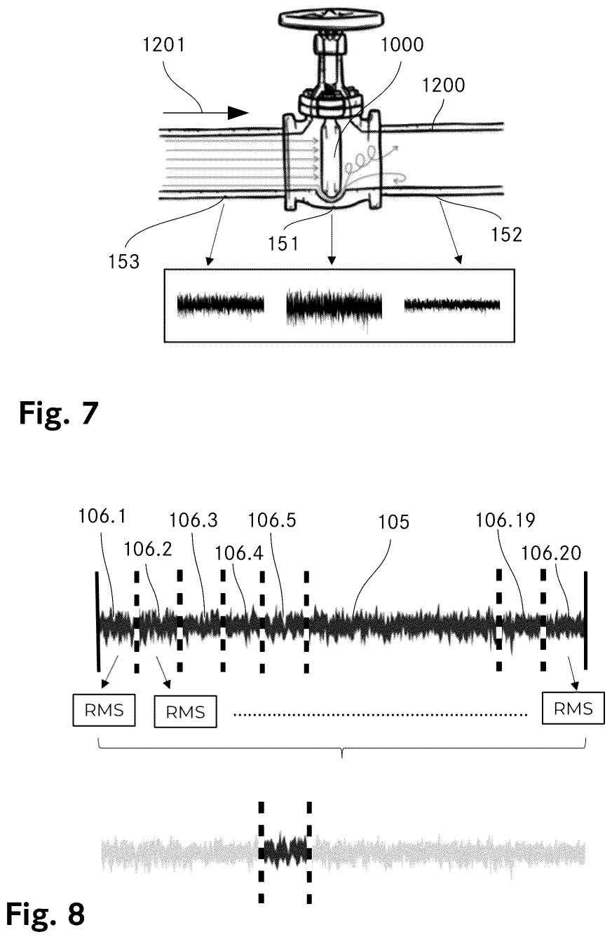

Apart from the rule-based procedure described above, the method according to the invention for establishing a diagnosis of a component can also be used to establish the diagnosis of the component using a different rule-based procedure. An example of such a different rule-based procedure is illustrated and described below with reference to FIGS. 7 to 11.

Shows a simplified schematic representation of a pipeline 1200, which is designed to conduct a fluid along a flow path in a flow path direction 1201. In the present example, the fluid is water in the liquid aggregate state. In variants to this, however, the fluid can also be water or water vapour or any other fluid.

In the pipeline 1200, a valve 1000 is installed as a component, on which component the method according to the invention for diagnosing a component or valve 1000 can be carried out by means of acoustic emission examination with the arrangement 1 shown in FIG. 1. In this embodiment example, the at least one acoustic emission sensor 2.1, 2.2 of the arrangement 1 serves for detecting a first acoustic emission signal at a first position 151 on the pipeline 1200 and outputting a first acoustic emission sensor signal, wherein the first acoustic emission sensor signal corresponds to the detected first acoustic emission signal, for detecting a second acoustic emission signal at a second position 152 on the pipeline 1200 and outputting a second acoustic emission sensor signal, wherein the second acoustic emission sensor signal corresponds to the detected second acoustic emission signal, and for detecting a third acoustic emission signal at a third position 153 on the pipeline 1200 and outputting a third acoustic emission sensor signal, wherein the third acoustic emission sensor signal corresponds to the detected third acoustic emission signal. Accordingly, the diagnostic unit 3 with the diagnostic module 4 is used for establishing the diagnosis of the valve 1000 taking into account the first acoustic emission sensor signal and the second acoustic emission sensor signal and the third acoustic emission sensor signal with the method according to the invention for establishing a diagnosis of the valve 1000. When carrying out this variant of the method according to the invention for diagnosing the valve 1000 by means of acoustic emission examination, one of the acoustic emission sensors 2.1, 2.2 detects the first acoustic emission signal at the first position 151 on the outside of the pipeline 1200 and the first acoustic emission sensor signal corresponding to the detected first acoustic emission signal is output by the one of the at least one acoustic emission sensor 2.1, 2.2 with which the first acoustic emission signal is detected at the first position 151 on the pipeline 1200. Furthermore, the second acoustic emission signal is detected by one of the at least one acoustic emission sensor 2.1, 2.2 at the second position 152 on the outside of the pipeline 1200 and the second acoustic emission sensor signal corresponding to the second acoustic emission signal is output by the one of the at least one acoustic emission sensor 2.1, 2.2 with which the second acoustic emission signal is detected at the second position 152 on the pipeline 1200. In addition, the third acoustic emission signal is detected by one of the at least one acoustic emission sensor 2.1, 2.2 at the third position 153 on the outside of the pipeline 1200 and the third acoustic emission sensor signal corresponding to the third acoustic emission signal is output by the one of the at least one acoustic emission sensor 2.1, 2.2 with which the third acoustic emission signal is detected at the third position 153 on the pipeline 1200.

In FIG. 7, the first acoustic emission sensor signal, the second acoustic emission sensor signal and the third acoustic emission sensor signal are shown symbolically in the rectangle in the lower area of the figure. The arrows shown in FIG. 7 from the pipeline 1200 to the acoustic emission sensor signals illustrate where on the pipeline 1200 or at which of the first position 151, second position 152 and third position 153 the respective acoustic emission sensor signal has been detected.

In the present embodiment, the first position 151 is located at a level of the valve 1000 installed in the pipeline 1200 as viewed in the flow guiding direction 1201. Further, the second position 152 is located on the pipeline 1200 distanced from the first position 151 as viewed in the flow guiding direction. Further, the third position 153 is located on a different side of the first position 151 as viewed along the flow path than the second position 152 is located from the first position 151, whereby the first position 151 is located between the second position 152 and the third position 153 as viewed along the flow path.

Before the respective acoustic emission signal is detected at each of the positions 151, 152, 153 with the respective one of the at least one acoustic emission sensor 2.1, 2.2, the respective acoustic emission sensor 2.1, 2.2, with which the respective acoustic emission signal is detected at the respective position 151, 152, 153 on the outside of the pipeline 1200, the respective acoustic emission sensor 2.1, 2.2 is positioned at the respective position 151, 152, 153 on the outside of the pipeline 1200 and an acoustic coupling of the respective acoustic emission sensor 2.1, 2.2 to the pipeline 1200 is checked.

If the respective acoustic emission signal is detected at the respective positions 151, 152, 153 by the respective acoustic emission sensor 2.1, 2.2 and the acoustic emission sensor signal corresponding to the respective detected acoustic emission signal is output by the respective acoustic emission sensor 2.1, 2.2, the respective acoustic emission signal is continuously detected by the respective at least one acoustic emission sensor 2.1, 2.2 for a period of 2 seconds. The sound emission sensor signals output are determined in each case to the diagnostic unit 3 with the diagnostic module 4 and the diagnosis of the valve 1000 is established with the diagnostic module 4 using the method according to the invention for establishing a diagnosis of the valve 1000.

As illustrated with reference to FIG. 8, the acoustic emission sensor signals 105 are filtered with a prefilter for establishing the diagnosis of the valve 1000, wherein the prefilter comprises a prefilter criterion, wherein the prefiltered acoustic emission sensor signals are used as acoustic emission sensor signals for further processing of the acoustic emission sensor signals for establishing the diagnoses of the valve 1000.

As shown in FIG. 8, the prefiltering includes the time-resolved reproduction of the respective detected acoustic emission signal by the respective acoustic emission sensor signal 105 and the subdivision of the respective time-resolved acoustic emission sensor signal 105 into sections 106.1, . . . , 106.20. As already mentioned, in the present example the acoustic emission sensor signals 105 each correspond to an acoustic emission signal continuously detected during a period of 2 s. The respective time-resolved acoustic emission sensor signal 105 is divided into 20 sections 106.1, . . . , 106.20. Thus, one section 106.1, . . . , 106.20 corresponds to 100 ms of continuously detected acoustic emission signal.

For prefiltering, a characteristic number of the respective sound emission sensor signal 105 is then determined for each of the sections 106.1, . . . , 106.20 of the respective sound emission sensor signal 105, whereby the prefilter criterion is applied to the values of the at least one characteristic number determined for the various sections 106.1, . . . , 106.20 and a section 106.1, . . . , 106.20 of the respective acoustic emission sensor signal 105 is selected on the basis of the prefilter criterion and the selected section 106.1, . . . , 106.20 is used as the respective prefiltered acoustic emission sensor signal 105 for establishing the diagnosis of the valve 1000. This prefiltering is carried out by a prefilter module 6, which is part of the diagnostic module 4 of the arrangement 1 shown in FIG. 1.

In the present example, the characteristic number is the root mean square (RMS_{section}) of the respective acoustic emission sensor signal 105 within the respective section 106.1, . . . , 106.20. The root mean square (RMS_{section}) is calculated according to the formula

$${RMS}_{s e c t i o n} = \sqrt{\frac{1}{m} {Σ}_{j = 1}^{m} {w}_{j}^{2}} ,$$

wherein m is the number of data points in the respective section 106.1, . . . , 106.20 of the respective acoustic emission sensor signal 105 and wⱼ is the value of the j-th data point in the respective section 106.1, . . . , 106.20 of the respective acoustic emission sensor signal 105. In FIG. 8, these values of the root mean square (RMS_{section}) are shown symbolically as rectangles labelled “RMS”.

Furthermore, in the present example, the prefilter criterion is the median value of the values of the characteristic number or the root mean square (RMS_{section}) determined for the sections 106.1, . . . , 106.20 of the respective acoustic emission sensor signal 105. Accordingly, that section 106.1, . . . , 106.20 of the respective acoustic emission sensor signal 105 is used as the respective pre-filtered acoustic emission sensor signal whose value of the root mean square (RMS_{section}) comes closest to the median value of the values of the root mean square (RMS_{section}) determined for the sections 106.1, . . . , 106.20 of the respective acoustic emission sensor signal 105. Since in the present example the respective acoustic emission sensor signal 105 is divided into an even number of sections 106.1, . . . , 106.20, one of those sections 106.1, . . . , 106.20 of the respective acoustic emission sensor signal 105 is used as the respective pre-filtered acoustic emission sensor signal whose value of the root mean square (RMS) section is the median or whose value is the lower median or upper median, as the case may be.

If one of the acoustic emission sensor signals for the various sections 106.1, . . . , 106.20 detects excessive differences in the value of the root mean square (RMS_{section}), the corresponding acoustic emission sensor signal can be recorded at the respective first position 151, second position 152 and third position 153. For this purpose, the arrangement 1 can, for example, directly request the user to record the respective acoustic emission sensor signal again.

Further, in the method, an acoustic emission sensor signal can also be detected at different positions in the flow guiding direction 1201 as seen at the level of the valve 1000 installed in the pipeline 1200. Subsequently, these acoustic emission sensor signals can be pre-filtered as described above, whereby the acoustic emission sensor signal which has the largest value of the root mean square (RMS_{section}) is used as the first acoustic emission sensor signal. This acoustic emission sensor signal can thus be used as the first acoustic emission signal detected at the first position 151 as seen in the flow guiding direction 1201 at the level of the valve 1000 installed in the pipeline 1200. With this procedure, it is achieved that the first acoustic emission sensor signal used for the further method includes the clearest signal of the valve.

For the further procedure when establishing the diagnosis of the valve 1000, a Fast Fourier Transform is calculated from each of the recorded acoustic emission signals. In other words, in the present case, the Fast Fourier Transform is calculated from the pre-filtered acoustic emission sensor signal to establishing the diagnosis of the valve 1000, after which this Fast Fourier Transform is further used to establish the diagnosis of the component. The acoustic emission sensor signals are further analysed over a sub-range of the frequency range over which the acoustic emission signals are detected. As the fluid medium in the present case is water in a liquid aggregate state, this sub-range is from 20 kHz to 400 KHz.

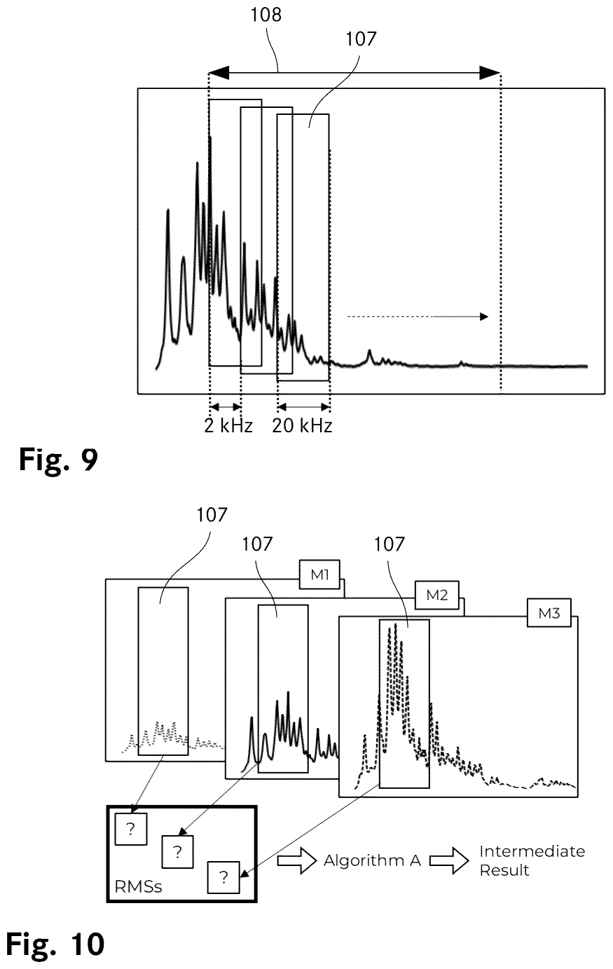

FIG. 9 shows the Fast Fourier Transformation of one of the pre-filtered acoustic emission sensor signals. In other words, FIG. 9 illustrates the further processing of an acoustic emission sensor signal using an acoustic emission sensor signal shown in frequency space. As illustrated in FIG. 9, the acoustic emission sensor signals are analysed to establish the diagnosis of the valve 1000 by determining a value of a characteristic number for each of the area sections 107 of the sub-range 108 that are offset from one another. The area sections 107 each have a width of 20 KHz and are offset from each other by 2 kHz. The characteristic number is the root mean square (RMS_{area section}), which is calculated using the formula

$${RMS}_{area section} = \sqrt{\frac{1}{p} {Σ}_{i = 1}^{p} {f}_{i}^{2}} ,$$

where p is the number of data points in the area section and fᵢ is the value of the i^{th} data point in the area section.

As illustrated in FIG. 10, the diagnosis of the valve 1000 is thereby established taking into account the first acoustic emission sensor signal, the second acoustic emission sensor signal and the third acoustic emission sensor signal. For this purpose, the Fast Fourier Transform of the pre-filtered first acoustic emission sensor signal is shown in FIG. 10 labelled as “M2”, while the Fast Fourier Transform of the pre-filtered second acoustic emission sensor signal is labelled as “M3” and the Fast Fourier Transform of the pre-filtered third acoustic emission sensor signal is labelled as “M1”.

Thus, the diagnosis of the valve 1000 is established taking into account the first acoustic emission sensor signal and two further acoustic emission sensor signals. The first position 151, at which the first acoustic emission signal has been detected by one of the acoustic emission sensors 2.1, 2.2 on the pipeline 1200, is located between the two positions 152, 153, at which the two other acoustic emission signals have been detected, when viewed along the flow path. To establish the diagnosis, a classification is carried out using the root mean square (RMS_{area section}) as a characteristic number for each of the 181 area sections 107, in that the respective area section 107 is classified as belonging to a first class precisely when the condition is met for the root mean square (RMS_{area section}), according to which condition the root mean square (RMS_{area section}) has a value determined for the respective area section 107 of the first acoustic emission sensor signal, which value is greater by at least one classification threshold value than the value determined for the respective area section 107 of the one of the two further acoustic emission sensor signals and is greater by at least the classification threshold value than the value determined for the respective area section 107 of the other of the two further acoustic emission sensor signals. This procedure is referred to in FIG. 10 as “Algorithm A”, which leads to an intermediate result referred to as “Intermediate Result”.

When performing this classification of the area sections 107, the classification threshold value may be a constant value. However, in the present example, the classification threshold value is a relative value. More precisely, the classification threshold value is a percentage of the value of the root mean square (RMS_{area section}), which value is determined for the respective area section 107 for the respective one of the two other acoustic emission sensor signals and is compared for the classification with the value of the root mean square (RMS_{area section}) determined for the respective area section 107 of the first acoustic emission sensor signal. The classification threshold value is selected as a function of the pressure difference in the pipeline 1200 across the valve 1000 installed in the pipeline 1200. If the pressure difference in the pipeline 1200 across the valve 1000 installed in the pipeline is less than 0.5 bar, the classification threshold value is 15% of the value of the root mean square (RMS_{area section}), which value is determined for the respective area section 107 for the respective one of the two other sound emission sensor signals and is compared for the classification with the value of the root mean square (RMS_{area section}) determined for the respective area section 107 of the first sound emission sensor signal. On the other hand, when the pressure difference in the pipeline 1200 across the valve 1000 installed in the pipeline 1200 is 0.5 bar or more, the classification threshold value is 25% of the value of the root mean square (RMS_{area section}), which value is determined for the respective area section for the respective one of the two other of the acoustic emission sensor signals and is just compared with the value of the root mean square (RMS_{area section}) determined for the respective area section 107 of the first acoustic emission sensor signal for classification. By selecting the classification threshold value in this way as a function of the pressure difference in the pipeline 1200 across the valve 1000 installed in the pipeline 1200, it is taken into account that a larger pressure difference generally results in a larger noise level in the detected acoustic emission signals. This higher noise level leads to greater statistical fluctuations in the recorded acoustic emission signals for a given state of the valve 1000, which means that the determined value of the root mean square (RMS_{area section}) also shows statistically greater deviations. These statistically larger deviations can be taken into account with the larger classification threshold value for a larger pressure difference in the pipeline.

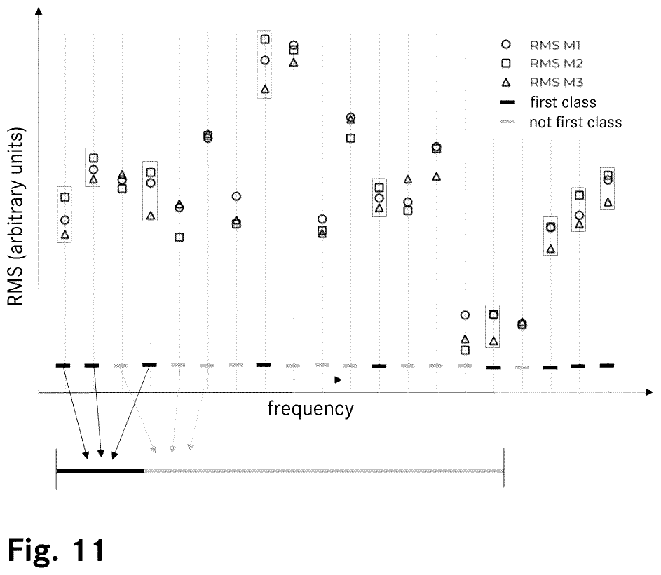

FIG. 11 shows a graph of the determined values of the root mean square (RMS_{area section}) for the various area sections 107 of the three acoustic emission sensor signals to illustrate the further method for establishing the diagnosis of the valve 1000. The horizontal axis is symbolically labelled as “frequency”, as the values for the various area sections 107 are lined up along the horizontal axis according to the respective frequency range of the respective area section. The values of the root mean square (RMS_{area section}) determined for the respective area section 107 of the third acoustic emission sensor signal are each shown as circles (“RMS M1”). The values of the root mean square (RMS_{area section}) determined for the respective area section 107 of the third acoustic emission sensor signal are each shown as squares (“RMS M2”). The values of the root mean square (RMS_{area section}) determined for the respective area section 107 of the second acoustic emission sensor signal are each shown as triangles (“RMS M3”). For those area sections 107 which were classified as belonging to the first class, a black horizontal bar is shown below the values of the respective area section 107. For those area sections 107 which have not been classified as belonging to the first class, a grey horizontal bar is indicated below the values of the respective area section 107. As illustrated at the bottom of FIG. 11, the proportion of area sections 107 classified as belonging to the first class in the total number of area sections 107 is then analysed in order to establish the diagnosis of the valve 1000.

More specifically, as a diagnosis of the valve 1000, the valve 1000 is diagnosed as defective when a proportion of the 181 area sections 107 has been classified as belonging to the first class, which proportion is greater than a quota threshold value. In the present embodiment, this quota threshold value is 3% of the 181 area sections 107. Thus, if 3% or more of the 181 area sections 107 have been classified as belonging to the first class, the valve 1000 is diagnosed as defective. On the other hand, if less than the quota threshold value of 3% of the 181 area sections 107 has been classified as belonging to the first class, the valve 1000 is diagnosed as not defective and thus as intact. However, this quota threshold value can also be selected differently. For example, the quota threshold value may be at least 2% of the area sections 107 or at least 5% of the area sections 107.

With the procedure described above, the respective area section 107 is classified as belonging to the first class precisely when the difference between the value of the root mean square (RMS area section) determined for the respective area section 107 of the first acoustic emission sensor signal and the values of the root mean square (RMS area section) determined for the respective area section 107 of the two other acoustic emission sensor signals indicates a defective component. Since the first position 151, at which one of the acoustic emission sensors 2.1, 2.2 on the pipeline 1200 is located between the two positions 152, 153 along the flow path at which the two other acoustic emission signals have been detected, noise caused by sources located away from the first position 151 and thus away from the valve 100 for which the diagnosis is being established can be masked out particularly efficiently, as only area sections 107 are classified as belonging to the first class in which the noise is not present in the detected acoustic emission signals or at least only plays a subordinate role. By diagnosing the valve 1000 as defective when the proportion of area sections 107 classified as belonging to the first class is greater than the quota threshold value, it is also possible to take into account how clearly the acoustic emission sensor signals indicate a leaking valve 1000 when establishing the diagnosis of the valve 1000, whereby the frequency at which the indications occur is irrelevant. On the one hand, this makes it possible to recognise different types of leaks in the valve 1000, which can cause signatures at different frequencies in the acoustic emission sensor signals. On the other hand, frequency ranges in which interference noises occur that are caused by sources located away from the first position 151 and thus away from the valve 100 can also be masked out. This enables establishing a very reliable diagnosis of the valve 1000.

Apart from the rule-based procedures described above, in the method according to the invention for establishing a diagnosis of a component, the diagnosis of the component can also be established as explained below by an evaluation method based on supervised machine learning.

Thereby, the supervised machine learning is achieved by training an algorithm with training data. The thereby, the training data comprised training data sets, with each training data set representing a test measurement on a pipeline 200 and, in addition to the respective acoustic emission sensor signals associated with the test measurement, which correspond to the respective acoustic emission signals detected on the pipeline 200, also contain the state of the component, which state is to be diagnosed for the respective test measurement. If the component is a valve, the state of the valve to be diagnosed can be binary and have the value “tight” or the value “leaking”. However, the valve condition to be diagnosed can also include the leakage rate of the valve if the valve showed a leak during the respective test measurement. The training data sets can, for example, be the measurements shown in FIGS. 2 to 6, whereby the respective training data set can also include further information such as the aforementioned information on the fluid, pressure, pipeline 200, component 100, but also on the coupling strengths of the acoustic emission sensors 2.1, 2.2 during detection of the respective acoustic emission signals. In particular, the acoustic emission signals recorded on a test stand, as shown in FIGS. 2, 3 and 4, can be used, as the condition of the component or the leakage rate of the valve can be precisely determined there and included in the respective training data set. However, measurements can also be used as training data sets, which, like the measurements shown in FIGS. 5 and 6, were taken on pipelines 200 in production plants. Furthermore, for each training data set, the values of a characteristic number determined for the sub-ranges described above can also be included in the respective training data set. In this case, these values of the respective characteristic number for the respective sub-range must ultimately be determined during the execution of the procedure and also transmitted to the algorithm for evaluation for the diagnosis of the component 100. However, it is also possible for the acoustic emission sensor signals to be transmitted to the algorithm for evaluation for the diagnosis of the component 100 only after the correction for the coupling strength or without the correction for the coupling strength. In other words, it is possible to transmit the acoustic emission sensor signals to the algorithm in time-resolved or frequency-resolved form as a Fast Fourier Transform, if necessary as described above in connection with FIG. 2, as a continuous quadratic mean for evaluation for the diagnosis of the component 100. However, the algorithm should have been trained in advance with training data available in the same form.

In a first embodiment, a random forest approach was used as an algorithm for supervised machine learning. The random forest approach is a meta-estimator that fits a set of decision tree classifiers to different subsamples of the dataset and uses averaging to improve prediction accuracy and control overfitting. The number of random trees was set to 100 and the maximum depth was not restricted. The minimum number of samples required to split an internal node was left at the default value of 2.

To train the algorithm, training data was used with training data sets that were recorded on a test stand with a test pipe with a test valve installed in it, as described in connection with FIGS. 2 to 4. The training data comprised twice as many training data sets for a leaking test valve as training data sets for a tight test valve. When training the algorithm, care was taken to ensure that at least 40 training data sets were available for each class to ensure that the trained algorithm was able to diagnose both leaking and tight valves.

Each training data set contained the first training acoustic emission sensor signal, the second training acoustic emission sensor signal and the third training acoustic emission sensor signal, the respective coupling strength of the respective acoustic emission sensor when detecting the respective corresponding acoustic emission signal, the valve type of the test valve, the information as to whether the valve was tight or leaking, and the information as to whether the fluid was water, steam or air. The training data sets also contained information on the pressure drop across the test valve and the root mean square (RMS) determined for sub-ranges of the respective test acoustic emission sensor signal, whereby the sub-ranges described above were selected from the recorded frequency range depending on whether the fluid was water, vapour, gas or air.

The test acoustic emission sensor signals each had a length of 216 data points. The test acoustic emission sensor signals were corrected for the respective coupling strength and a Hanning window was applied to them before the Fast Fourier Transform was calculated from the test acoustic emission sensor signals. The Fast Fourier Transform was then smoothed using a Gaussian filter with a width of 100 data points and the result was converted to a logarithmic (dB) scale. These logarithmic intensity curves and also the pressure drop across the test valve as well as the root mean square (RMS) determined for the sub-ranges of the respective test acoustic emission sensor signal were scaled to a given range of values for all training data sets in order to obtain comparable magnitudes.

The classification model was run a total of 100 times and the best result was selected. The selection was based on the fact that the classification model had to be better than an initially specified minimum evaluation of accuracy, precision, true positives, true negatives and false negatives. The selected best classification model was then used to perform the method according to the invention.

As a result, using the random forest approach as an algorithm for supervised machine learning, the method according to the invention was able to correctly diagnose a valve, i.e. whether the valve was tight or leaking, with an accuracy of over 90%, with a precision of over 90% and a hit rate of over 90%.

In a second embodiment, a custom-designed neural network approach was used as an algorithm for supervised machine learning. In a custom-designed neural network, a window is moved over the signal and relevant features are identified at different levels (from low to high). These features are identified automatically without knowing in advance which features they will ultimately be. The custom-designed neural network approach makes it possible to maintain correlation between the features. In this example, the final architecture consisted of 3 convolutional layers to extract patterns, followed by three dense decision layers. A binary cross entropy was chosen as the loss function, as the model should ultimately solve the binary question or binary classification task of whether the valve has a leak or not. In order to optimise the learning rate and improve the result, a look-ahead mechanism was also used, as this makes the model less sensitive to suboptimal hyperparameters and thus reduces the need for extensive hyperparameter tuning. The LookAhead mechanism was used in combination with RectifiedAdam, which was the most powerful optimiser for the model.

In the second embodiment example using the custom-designed neural network approach, similar training data was used to train the algorithm as was used to train the algorithm in the first embodiment example using the random forest approach. However, in the second example using the custom-designed neural network approach, the Fast Fourier Transform of the training sound emission sensor signals were smoothed three times in succession using a Gaussian filter with a width of 100 data points and the result was then quadratically distorted in the x-axis in order to enhance the features that are more significant at lower frequencies.

As a result, using the custom-designed neural network approach as an algorithm for supervised machine learning with the method according to the invention, the diagnosis of a valve, i.e. whether the valve was tight or leaking, could be established correctly with an accuracy of over 90%, with a precision of over 90% and a hit rate of over 90%.

The invention is not limited to the embodiments described above. If, in the method for establishing a diagnosis of a component, the diagnosis of the component is establishing by an evaluation method based on supervised machine learning, other features not described above can also be used to train the algorithm. For example, the curvature (“kurtosis”) of the acoustic emission sensor signals can be used as a feature. Furthermore, the skewness of the acoustic emission sensor signals can be used as a feature. Also, the energy of the acoustic emission sensor signals, which energy is the area under the curve of the square of the absolute value of the respective acoustic emission sensor signal, can be used as a feature. The standard deviation of the acoustic emission sensor signals can also be used as a feature. Furthermore, the histograms of the voltages output by the respective acoustic emission sensor, which correspond to the output acoustic emission sensor signals, can be used as a feature. Zero crossings of the acoustic emission sensor signals can also be prevented as an indicator of the signal noise present in the respective acoustic emission sensor signal as a feature. In addition, the spectral centres of the acoustic emission sensor signals can be used as a feature. The spectral centroids indicate where the centre of mass of the respective acoustic emission sensor signal is located. It is calculated as a weighted average of the frequencies present in the respective acoustic emission sensor signal, whereby the weights are formed by the values of the Fast Fourier Transform at the respective frequencies. The ratio of the signal to the noise can also be used as a feature. Furthermore, an additive white Gaussian noise can also be added to the acoustic emission sensor signals in the training data in order to prevent overfitting of the model.

To summarise, a method belonging to the above-mentioned technical field for establishing a diagnosis of a component, in particular a valve, which component is installed in a pipeline, which pipeline is designed for guiding a fluid along a flow path in a flow guiding direction, is created by means of acoustic emission examination, which method enables establishing a more accurate and reliable diagnosis of the component. Further, a computer program product for carrying out this method is created, which enables establishing a more accurate and reliable diagnosis of the component. In addition, a method for diagnosing a component, in particular a valve, which component is installed in a pipeline, which pipeline is designed for guiding a fluid along a flow path in a flow guiding direction, by means of acoustic emission examination is created and an arrangement for carrying out the method for diagnosing the component, in particular valve, by means of acoustic emission examination is created, which enables a more accurate and reliable diagnosis of the valve.

1. A method for establishing a diagnosis of a component, by acoustic emission examination, wherein the component is installed in a pipeline, wherein the pipeline is configured for guiding a fluid along a flow path in a flow guiding direction, wherein the diagnosis of the component is established taking into account a first acoustic emission sensor signal, a second acoustic emission sensor signal, and a third acoustic sensor signal, wherein a distinguishing feature between the first acoustic emission sensor signal and the second acoustic emission sensor signal and a distinguishing feature between the first acoustic emission sensor signal and the third acoustic emission sensor signal are also taken into account for establishing the diagnosis,
a) wherein the first acoustic emission sensor signal has been output by one of at least one acoustic emission sensor, wherein a first acoustic emission signal has been detected by the respective one of the at least one acoustic emission sensor at a first position on the pipeline, wherein the first acoustic emission sensor signal output by the respective one of the at least one acoustic emission sensor corresponds to the detected first acoustic emission signal, wherein the first position is located at a height of the component installed in the pipeline as viewed in the flow guiding direction,
b) wherein the second acoustic emission sensor signal has been output by one of the at least one acoustic emission sensor, wherein a second acoustic emission signal has been detected at a second position on the pipeline by the respective one of the at least one acoustic emission sensor, wherein the second acoustic emission sensor signal output by the respective one of the at least one acoustic emission sensor corresponds to the detected second acoustic emission signal, wherein the second position is located on the pipeline at a distance from the first position in the flow guiding direction or against the flow guiding direction,
c) the third acoustic emission sensor signal has been output by one of the at least one acoustic emission sensors, wherein a third acoustic emission signal has been detected with the respective one of the at least one acoustic emission sensors at a third position on the pipeline, wherein the third acoustic emission signal output by the respective acoustic emission sensor corresponds to the detected third acoustic emission signal, wherein the third position is located on a different side of the first position than the second position is located from the first position when viewed along the flow path, whereby the first position is located between the second position and the third position as viewed along the flow path,
wherein, for the purpose of establishing the diagnosis of the component, the acoustic emission sensor signals are evaluated over at least two mutually offset range sections of the frequency range over which frequency range the acoustic emission signals are detected, wherein at least one characteristic number of the respective acoustic emission sensor signal is determined for each of these at least two mutually offset range sections,
wherein the diagnosis of the component is established taking into account the first acoustic emission sensor signal and at least two further ones of the acoustic emission sensor signals, wherein, as viewed along the flow path, the first position is located between the two positions at which two of the at least two further ones of the acoustic emission signals have been detected,
wherein either, a classification is carried out for each of the at least two area sections on the basis of one of the at least one characteristic number, wherein the respective area section is classified as belonging to a first class precisely when a condition is fulfilled for the one of the at least one characteristic number, according to which condition the one of the at least one characteristic number has a value determined for the respective area section of the first sound emission sensor signal, which value is greater by at least one classification threshold value than the value determined for the respective area section of the one of the two of the at least two further acoustic emission sensor signals and is greater by at least the classification threshold value than the value determined for the respective area section of the other of the two of the at least two further acoustic emission sensor signals,
or wherein a classification is carried out on the basis of the one of the at least one characteristic number for each of the at least two area sections, wherein the respective area section is classified as belonging to the first class precisely when a condition is fulfilled for the one of the at least one characteristic number, according to which condition the one of the at least one characteristic number has a value determined for the respective area section of the first acoustic emission sensor signal, which value is smaller by at least the classification threshold value than the value determined for the respective area section of the one of the two of the at least two further acoustic emission sensor signals and is smaller by at least the classification threshold value than the value determined for the respective area section of the other of the two of the at least two further acoustic emission sensor signals, and
wherein, if a quota of the at least two area sections has been classified as belonging to the first class, which quota is greater than a quota threshold value, the component is diagnosed as defective as a diagnosis of the component.

2. (canceled)

3. (canceled)

4. The method according to claim 1, wherein the acoustic emission signals detected with the at least one acoustic emission sensor, are detected over a frequency range.

5. The method according to claim 1, wherein, for establishing the diagnosis of the component, the acoustic emission sensor signals are filtered with a prefilter, the prefilter comprising a prefilter criterion, wherein for establishing the diagnosis of the component, for further processing of the acoustic emission sensor signals, the prefiltered acoustic emission sensor signals are used as acoustic emission sensor signals.

6. The method according to claim 1, wherein an aggregate state of the fluid and/or a medium of the fluid is also taken into account for establishing the diagnosis of the component.

7. The method according to claim 1, wherein a pressure difference in the pipeline across the component installed in the pipeline is also taken into account for establishing the diagnosis of the component.

8. The method according to claim 4, wherein, for establishing the diagnosis of the component, the acoustic emission sensor signals are evaluated over a sub-range of the frequency range over which frequency range the acoustic emission signals are detected.

9. The method according to claim 8, wherein, for the purpose of establishing the diagnosis of the component, the acoustic emission sensor signals are evaluated over the sub-range of the frequency range over which frequency range the acoustic emission signals are detected, wherein at least one characteristic number of the respective acoustic emission sensor signal is determined for this the sub-range.

10. The method according to claim 1, wherein, for the purpose of establishing the diagnosis of the component, the acoustic emission sensor signals are evaluated over the sub-range of the frequency range over which frequency range the acoustic emission signals are detected, wherein at least one characteristic number of the respective acoustic emission sensor signal is determined for the sub-range, and
wherein the diagnosis of the component is established taking into account the first acoustic emission sensor signal and at least two further ones of the acoustic emission sensor signals, the first position being located between the two positions at which two of the at least two further ones of the acoustic emission signals have been detected, as viewed along the flow path,
wherein, if a condition is met for one of the at least one characteristic number, according to which condition the one of the at least one characteristic number determined for the sub-range of the first acoustic emission sensor signal has a value which is between the value determined for the sub-range of the one of the two of the at least two further of the acoustic emission sensor signals and the value determined for the sub-range of the other of the two of the at least two further of the acoustic emission sensor signals, the sub-range within the frequency range over which frequency range the acoustic emission signals are detected is shifted to higher frequencies, and the acoustic emission sensor signals are evaluated over the shifted sub-range of the frequency range over which frequency range the acoustic emission signals are detected in order to establish the diagnosis of the component the at least one characteristic number of the respective acoustic emission sensor signal is determined for this shifted sub-range.

11. The method according to claim 9, wherein the diagnosis of the component is made taking into account the first acoustic emission sensor signal and at least one other of the acoustic emission sensor signals, and
wherein, if a condition is fulfilled for one of the at least one characteristic number, according to which condition the one of the at least one characteristic number determined for the sub-range of the first acoustic emission sensor signal has a value which is greater by at least one threshold value than the value determined for the sub-range of the at least one other of the acoustic emission sensor signals, the component is diagnosed as defective as a diagnosis of the component.

12. (canceled)

13. (canceled)

14. (canceled)

15. The method according to claim 1, wherein the diagnosis of the component is established by an evaluation method based on supervised machine learning.

16. (canceled)

17. A method for diagnosing a component by acoustic emission examination, wherein the component is installed in a pipeline, wherein the pipeline is configured for guiding a fluid along a flow path in a flow guiding direction,
a) wherein the first acoustic emission signal is detected by one of at least one acoustic emission sensor at a first position on the pipeline and the first acoustic emission sensor signal corresponding to the detected first acoustic emission signal is output by that of the at least one acoustic emission sensor by which the first acoustic emission signal is detected at the first position on the pipeline,
b) wherein the second acoustic emission signal is detected by one of the at least one acoustic emission sensor at a second position on the pipeline and the second acoustic emission sensor signal corresponding to the second acoustic emission signal is output by the one of the at least one acoustic emission sensor by which the second acoustic emission signal is detected at the second position on the pipeline,
c) wherein the third acoustic emission signal is detected by one of the at least one acoustic emission sensor at the third position on the pipeline and the third acoustic emission sensor signal corresponding to the third acoustic emission signal is output by the of the at least one acoustic emission sensor by which the third acoustic emission signal is detected at the third position on the pipeline,
wherein the first acoustic emission sensor signal is transmitted to a diagnostic module connected to that of the at least one acoustic emission sensor with which the first acoustic emission signal has been detected for establishing the diagnosis of the component, the second acoustic emission sensor signal is transmitted to the diagnostic module connected to that of the at least one acoustic emission sensor with which the second acoustic emission signal has been detected for establishing the diagnosis of the component and the third acoustic emission sensor signal is transmitted to the diagnostic module connected to the one of the at least one acoustic emission sensor with which the third acoustic emission signal has been detected for establishing the diagnosis of the component and the diagnosis of the component is established by the diagnostic module, taking into account the first acoustic emission sensor signal, the second acoustic emission sensor signal, and the third acoustic emission sensor signal using the method according claim 1.

18. (canceled)

19. An arrangement for carrying out the method according to claim 17, comprising
a) at least one acoustic emission sensor for detecting a first acoustic emission signal at a first position on a pipeline and outputting a first acoustic emission sensor signal, wherein the first acoustic emission sensor signal corresponds to the detected first acoustic emission signal, for detecting a second acoustic emission signal at a second position on the pipeline and outputting a second acoustic emission sensor signal, the second acoustic emission sensor signal corresponding to the detected second acoustic emission signal, for detecting a third acoustic emission signal at a third position on the pipeline and outputting a third acoustic emission sensor signal, the third acoustic emission sensor signal corresponding to the detected third acoustic emission signal, and
b) a diagnostic unit with the diagnostic module for establishing the diagnosis of the component, taking into account the first acoustic emission sensor signal and the second acoustic emission sensor signal, the diagnostic unit configured to establish the diagnosis of the component with the method according to one of claim 1, wherein the diagnostic unit with the diagnostic module is connected to the one of the at least one acoustic emission sensor with which the first acoustic emission signal is to be detected for receiving the first acoustic emission sensor signal and is connected to the one of the at least one acoustic emission sensor with which the second acoustic emission signal is to be detected for receiving the second acoustic emission sensor signal and is connected to the one of the at least one acoustic emission sensor with which the third acoustic emission signal is to be detected for receiving the third acoustic emission sensor signal.

20. The method according to claim 5, wherein the prefiltering includes the time-resolved reproduction of the respective detected acoustic emission signal by the respective acoustic emission sensor signal and the subdivision of the respective time-resolved acoustic emission sensor signal into sections, whereafter for prefiltering, at least one characteristic number of the respective acoustic emission sensor signal is determined for each of the sections of the respective acoustic emission sensor signal, wherein the prefilter criterion is applied to the values of the at least one characteristic number determined for the various sections and one or more sections of the respective acoustic emission sensor is selected on the basis of the prefilter criterion and the selected section or sections are used as the respective prefiltered acoustic emission sensor signal for establishing the diagnosis of the component.
